(19) United States
(12) Patent Application Publication
(10) Pub. No.: US 2026/0175566 A1
(43) Pub. Date: Jun. 25, 2026

(54) LIQUID EJECTING APPARATUS

(71) Applicant: SEIKO EPSON CORPORATION, Tokyo (JP)

(72) Inventor: Koji KITAZAWA, Shiojiri (JP)

(21) Appl. No.: 19/428,400

(22) Filed: Dec. 22, 2025

(30) Foreign Application Priority Data
Dec. 24, 2024 (JP) 2024-227990

(51) Int. Cl. B41J 2/045; B41J 2/165; B41J 2/17

(52) U.S. Cl. CPC B41J 2/04541; B41J 2/0451; B41J 2/0455; B41J 2/04551; B41J 2/04581; B41J 2/04588; B41J 2/16535; B41J 2/1707

(57) ABSTRACT

A liquid ejecting apparatus includes a sink circuit that switches, in accordance with a result of determining states of a plurality of ejection sections by a state determination circuit, an impedance value between first wiring through which a reference voltage signal to be supplied to a second end of a first piezoelectric element and a second end of a second piezoelectric element propagates and second wiring through which a signal having an electrical potential lower than an electrical potential of the reference voltage signal propagates. The sink circuit has a first mode in which the impedance value is set to a first impedance value, a second mode in which the impedance value is set to a second impedance value less than the first impedance value, and a third mode in which the impedance value is set to a third impedance value less than the second impedance value.

The present application is based on, and claims priority from JP Application Serial Number 2024-227990, filed Dec. 24, 2024, the disclosure of which is hereby incorporated by reference herein in its entirety.

### BACKGROUND

### 1. Technical Field

The present disclosure relates to a liquid ejecting apparatus.

### 2. Related Art

A liquid ejecting apparatus that ejects liquid by driving a piezoelectric element so as to cause the ejected liquid to land on a medium and form an image on the medium is known. The liquid ejecting apparatus drives the piezoelectric element by causing a difference in electrical potential between both ends of the piezoelectric element, and ejects the liquid onto the medium by the driving of the piezoelectric element.

In the liquid ejecting apparatus having the above-described configuration, in a case where an abnormality occurs in the piezoelectric element, there is a possibility that the ejection characteristics of the liquid may be reduced and the quality of the image formed on the medium may be reduced. To address such problems, JP-A-2023-137369 discloses a liquid ejecting apparatus including a piezoelectric element that is driven to eject liquid and in which the possibility of the occurrence of an abnormality is reduced.

However, it is not possible to completely reduce the possibility of the occurrence of an abnormality in the piezoelectric element with only the technique described in JP-A-2023-137369, and therefore the technique described in JP-A-2023-137369 is not sufficient from the viewpoint of reducing the possibility of a reduction in the quality of an image formed on a medium when an abnormality occurs in the piezoelectric element, and reducing the possibility of impairment of the convenience of the liquid ejecting apparatus, and there is room for further improvement.

### SUMMARY

According to an aspect of the present disclosure, a liquid ejecting apparatus includes a print head including a plurality of ejection sections including a first ejection section that ejects liquid by driving of a first piezoelectric element and a second ejection section that ejects liquid by driving of a second piezoelectric element; a drive circuit that outputs a drive signal to be supplied to a first end of the first piezoelectric element and a first end of the second piezoelectric element; a reference voltage circuit that outputs a reference voltage signal to be supplied to a second end of the first piezoelectric element and a second end of the second piezoelectric element; a state determination circuit that determines states of the plurality of ejection sections; and a sink circuit that switches, in accordance with a result of determining the states of the plurality of ejection sections by the state determination circuit, an impedance value between first wiring through which the reference voltage signal propagates and second wiring through which a signal having an electrical potential lower than an electrical potential of the reference voltage signal propagates, wherein the sink circuit has a first mode in which the impedance value is set to a first impedance value, a second mode in which the impedance value is set to a second impedance value less than the first impedance value, and a third mode in which the impedance value is set to a third impedance value less than the second impedance value.

### BRIEF DESCRIPTION OF THE DRAWINGS

FIG. 1 is a diagram illustrating an example of a functional configuration of a liquid ejecting apparatus.

FIG. 2 is a diagram illustrating an example of a schematic internal structure of the liquid ejecting apparatus.

FIG. 3 is a diagram illustrating a schematic structure of an ejection section.

FIG. 4 is a diagram illustrating an example of an arrangement of nozzles.

FIG. 5 is a diagram illustrating an example of a configuration of a drive circuit.

FIG. 6 is a diagram illustrating an example of a configuration of a reference voltage circuit.

FIG. 7 is a diagram illustrating an example of a configuration of a sink circuit.

FIG. 8 is a diagram illustrating an example of a functional configuration of a head unit.

FIG. 9 is a diagram for explaining an example of various signals input to a coupling state specifying circuit.

FIG. 10 is a diagram illustrating an example of a configuration of a waveform shaping circuit.

FIG. 11 is a diagram for explaining an example of various signals output by a control unit in a period of time when an ejection process is executed.

FIG. 12 is a diagram illustrating an example of a relationship between an individual specifying signal and coupling state specifying signals in the period of time when the ejection process is executed.

FIG. 13 is a diagram for explaining an example of various signals input to a supply switching circuit of the head unit in a period of time when a determination process is executed.

FIG. 14 is a diagram illustrating an example of a relationship between the individual specifying signal and the coupling state specifying signals in the period of time when the determination process is executed.

FIG. 15 is a diagram illustrating an example of a relationship between the individual specifying signal and coupling state specifying signals in the period of time when the determination process is executed.

FIG. 16 is a diagram for explaining an example of an operation of acquiring a detected electrical potential signal based on a signal corresponding to a residual vibration generated in an ejection section to be inspected.

FIG. 17 is a diagram illustrating an example of a pump suction process.

FIGS. 18A and 18B are diagrams illustrating an example of a wiping process.

FIG. 19 is a diagram for explaining the control of a sink capability in the sink circuit.

### DESCRIPTION OF EMBODIMENTS

Hereinafter, preferred embodiments of the present disclosure will be described with reference to the drawings. The drawings to be used are for convenience of description. The embodiments described below do not unduly limit the contents described in the appended claims. In addition, not all of configurations described below are necessarily essential components of the present disclosure.

### 1. Overview of Liquid Ejecting Apparatus

A liquid ejecting apparatus 1 according to the present embodiment will be described by taking, as an example, an ink jet printer that ejects ink as an example of liquid onto a medium such as recording paper and forms an image on the medium. The liquid ejecting apparatus 1 is not limited to the ink jet printer, and may be a color material ejecting apparatus that is used for manufacturing a color filter of a liquid crystal display or the like, an electrode material ejecting apparatus that is used for forming an electrode of an organic EL display, a field emission display (FED), or the like, a bio-organic material ejecting apparatus that is used for manufacturing a biochip, a three-dimensional shaping apparatus, a textile printing apparatus, or the like.

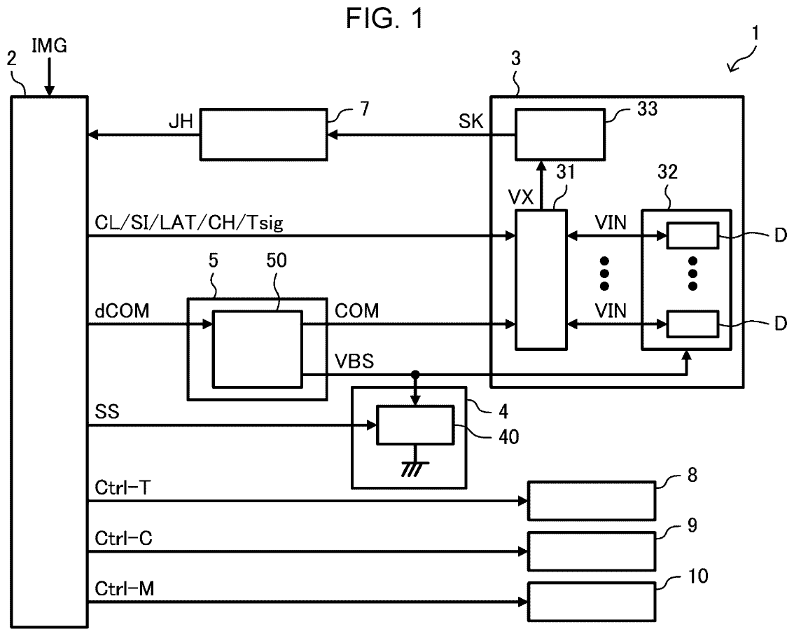

FIG. 1 is a diagram illustrating an example of a functional configuration of the liquid ejecting apparatus 1. The liquid ejecting apparatus 1 according to the present embodiment forms, on a medium, an image based on an image data signal IMG input from an external apparatus such as a computer. As illustrated in FIG. 1, the liquid ejecting apparatus 1 includes a control unit 2, a head unit 3, a sink unit 4, a drive circuit unit 5, a determination unit 7, a transport unit 8, a carriage moving unit 9, and a maintenance unit 10.

The control unit 2 controls components of the liquid ejecting apparatus 1 that include the head unit 3, the sink unit 4, the drive circuit unit 5, the determination unit 7, the transport unit 8, the carriage moving unit 9, and the maintenance unit 10. The control unit 2 includes one or a plurality of central processing units (CPUs) and a storage circuit. The control unit 2 may include a programmable logic device such as a field programmable gate array (FPGA) instead of the one or plurality of CPUs or in addition to the one or plurality of CPUs.

The image data signal IMG is input to the control unit 2. The control unit 2 generates, based on the input image data signal IMG, signals for controlling the operation of each of the components of the liquid ejecting apparatus 1, and outputs the generated signals to the corresponding components. The signals include a transport control signal Ctrl-T, a carriage control signal Ctrl-C, a maintenance control signal Ctrl-M, a clock signal CL, a print data signal SI, a latch signal LAT, a change signal CH, a period specifying signal Tsig, a drive waveform specifying signal dCOM, and a sink control signal SS.

The drive circuit unit 5 includes a drive circuit 50. The drive waveform specifying signal dCOM is input to the drive circuit 50. The drive circuit 50 generates a drive signal COM by amplifying a signal waveform defined by the input drive waveform specifying signal dCOM. The drive circuit 50 generates a reference voltage signal VBS together with the drive signal COM. Then, the drive signal COM and the reference voltage signal VBS generated by the drive circuit 50 are output from the drive circuit unit 5.

The sink unit 4 includes a sink circuit 40. The sink circuit 40 is coupled to wiring through which the reference voltage signal VBS propagates, and to wiring through which a ground electrical potential propagates. The sink control signal SS is input to the sink circuit 40. Based on a voltage value of the reference voltage signal VBS, the sink circuit 40 releases, with a sink capability defined by the sink control signal SS, electrical charge of the wiring, through which the reference voltage signal VBS propagates, to the wiring, through which the ground electrical potential propagates.

The clock signal CL, the print data signal SI, the latch signal LAT, the change signal CH, and the period specifying signal Tsig are input to the head unit 3. The drive signal COM and the reference voltage signal VBS output by the drive circuit unit 5 are input to the head unit 3. The head unit 3 controls the supply of the drive signal COM to a plurality of ejection sections D included in a recording head 32 (described later) in each of periods defined by the latch signal LAT, the change signal CH, and the period specifying signal Tsig in accordance with the print data signal SI propagated in synchronization with the clock signal CL. Accordingly, the operation of each of the plurality of ejection sections D, that is, the ejection of ink from each of the plurality of ejection sections D in each of the periods defined by the latch signal LAT, the change signal CH, and the period specifying signal Tsig is individually controlled.

Specifically, the head unit 3 includes a supply switching circuit 31, the recording head 32, and a detection circuit 33. The recording head 32 includes the plurality of ejection sections D. In the following description, it is assumed that the recording head 32 includes M ejection sections D. The M ejection sections D included in the recording head 32 may be referred to as ejection sections D[1] to D[M] in a case where the ejection sections D are individually specified and described. In this case, in a case where an m-th ejection section D among the M ejection sections D included in the recording head 32 is specified and described, the m-th ejection section D may be referred to as an ejection section D[m]. M is a positive integer satisfying “M≥1”, and m is any positive integer satisfying “1≤m≤M”. In the following description, in a case where a constituent element, a signal, or the like of the liquid ejecting apparatus 1 corresponds to the ejection section D[m] among the M ejection sections D, a suffix [m] may be added to a reference sign representing the constituent element, the signal, or the like.

The clock signal CL, the print data signal SI, the latch signal LAT, the change signal CH, the period specifying signal Tsig, and the drive signal COM are input to the supply switching circuit 31. The supply switching circuit 31 switches whether to supply the drive signal COM to a corresponding ejection section D among the plurality of ejection sections D as a supply drive signal VIN based on the print data signal SI at each timing defined by the latch signal LAT, the change signal CH, and the period specifying signal Tsig. When the supply drive signal VIN is supplied to a piezoelectric element PZ (described later) included in the ejection section D, the piezoelectric element PZ is driven. Then, ink in an amount corresponding to an amount by which the piezoelectric element PZ is driven is ejected from the ejection section D.

The supply switching circuit 31 acquires a signal corresponding to a residual vibration generated in the ejection section D to be inspected, based on the print data signal SI at each timing defined by the latch signal LAT, the change signal CH, and the period specifying signal Tsig, and switches whether to supply the acquired signal to the detection circuit 33 as a detected electrical potential signal VX.

The detection circuit 33 generates a detection signal SK based on the detected electrical potential signal VX supplied through the supply switching circuit 31, and outputs the detection signal SK from the head unit 3. Specifically, the detection circuit 33 amplifies the input detected electrical potential signal VX, removes a noise component, and then converts the signal into a digital signal to generate the detection signal SK, and outputs the detection signal SK from the head unit 3.

The detection signal SK output from the head unit 3 is input to the determination unit 7. The determination unit 7 determines, based on the input detection signal SK, whether an ink ejection state of the ejection section D to be inspected is normal, that is, whether the ejection section D to be inspected is in a normal ejection state. Specifically, for example, the determination unit 7 reads predetermined determination threshold information and correction value information from a storage circuit (not illustrated) including a nonvolatile memory such as a read-only memory (ROM) or a flash memory. The determination unit 7 corrects the input detection signal SK in accordance with the read correction value information, and compares the corrected signal with the predetermined determination threshold information. Then, the determination unit 7 determines, in accordance with a result of the comparison, whether an ejection abnormality has occurred in the ejection section D to be inspected, that is, whether the ejection section D to be inspected is in the normal ejection state. Thereafter, the determination unit 7 generates a state determination signal JH indicating a result of the determination and outputs the generated state determination signal JH to the control unit 2.

In the following description, determining whether an ejection abnormality has occurred in the ejection section D to be inspected, that is, determining whether the ejection section D to be inspected is in the normal ejection state may be simply referred to as determining the state of the ejection section D to be inspected. The ejection abnormality is a state in which the ink ejection state of the ejection section D to be inspected is abnormal, and is a general term of a state in which ink cannot be accurately ejected from the ejection section D to be inspected. The ejection abnormality includes, for example, a state in which ink cannot be ejected from the ejection section D, a state in which ink in an amount different from an amount of ink to be ejected that is defined by the drive signal COM is ejected from the ejection section D, and a state in which ink is ejected from the ejection section D at a speed different from an ink ejection speed defined by the drive signal COM.

The transport control signal Ctrl-T is input to the transport unit 8. The transport unit 8 controls, in accordance with the input transport control signal Ctrl-T, the transport of the medium on which ink lands. The carriage control signal Ctrl-C is input to the carriage moving unit 9. The carriage moving unit 9 controls movement of a carriage (described later) on which the head unit 3 is mounted. Therefore, the control unit 2 controls a relative position of the medium on which ink lands to the head unit 3 that ejects the ink.

The maintenance control signal Ctrl-M is input to the maintenance unit 10. The maintenance unit 10 executes a maintenance process in accordance with the input maintenance control signal Ctrl-M so as to attempt to restore the state of the ejection section D in which the ejection abnormality has occurred.

In the liquid ejecting apparatus 1 as described above, when an ejection process of forming the image based on the image data signal IMG on the medium by ejecting ink is executed, the control unit 2 generates, based on the input image data signal IMG, a signal such as the print data signal SI for controlling the head unit 3 to eject the ink, outputs the generated signal to the head unit 3, generates the drive waveform specifying signal dCOM for controlling the drive circuit unit 5 to output the drive signal COM for driving the ejection section D to eject the ink, and outputs the drive signal COM to the drive circuit unit 5. In this case, the control unit 2 generates and outputs the transport control signal Ctrl-T for controlling the transport unit 8 and the carriage control signal Ctrl-C for controlling the carriage moving unit 9. Accordingly, the ink ejected from the ejection section D lands on a desired position on the medium, and the image based on the image data signal IMG is formed on the medium.

When a determination process of determining the state of the ejection section D is executed, the control unit 2 generates a signal such as the print data signal SI for determining the state of the ejection section D to be inspected, outputs the generated signal to the head unit 3, generates the drive waveform specifying signal dCOM for controlling the drive circuit unit 5 to output the drive signal COM for determining the state of the ejection section D, and outputs the drive waveform specifying signal dCOM to the drive circuit unit 5. Accordingly, the detected electrical potential signal VX for the ejection section D to be inspected is input to the detection circuit 33 through the supply switching circuit 31. The detection circuit 33 acquires the input detected electrical potential signal VX, generates the detection signal SK corresponding to the acquired detected electrical potential signal VX, and outputs the detection signal SK to the determination unit 7. The determination unit 7 determines, based on the input detection signal SK, whether the ink ejection state of the ejection section D to be inspected is normal, that is, whether the ejection section D to be inspected is in the normal ejection state. Then, the determination unit 7 generates a state determination signal JH corresponding to a result of determining the state of the ejection section D to be inspected, and outputs the generated state determination signal JH to the control unit 2. Accordingly, the control unit 2 can acquire the state of the ejection section D to be inspected and correct various signals to be output, based on the acquired state of the ejection section D to be inspected. As a result, the quality of the image formed on the medium is improved.

Further, the control unit 2 outputs the maintenance control signal Ctrl-M for causing the maintenance unit 10 to execute the maintenance process. The maintenance unit 10 executes the maintenance process in accordance with the input maintenance control signal Ctrl-M so as to attempt to restore the state of the ejection section D in which the ejection abnormality has occurred. Accordingly, it is possible to restore the state of the ejection section D in which the ejection abnormality has occurred, and as a result, the quality of the image formed on the medium is improved.

As described above, the liquid ejecting apparatus 1 according to the present embodiment executes various processes including the ejection process of forming the image based on the image data signal IMG on the medium, the determination process of determining the state of the ejection section D that ejects ink onto the medium, and the maintenance process of attempting to restore the state of the ejection section D.

FIG. 1 illustrates a case where the liquid ejecting apparatus 1 includes one head unit 3. However, the liquid ejecting apparatus 1 may include a plurality of head units 3. In this case, the liquid ejecting apparatus 1 may include a control unit 2, a sink unit 4, a drive circuit unit 5, and a determination unit 7 for each of the plurality of head units 3.

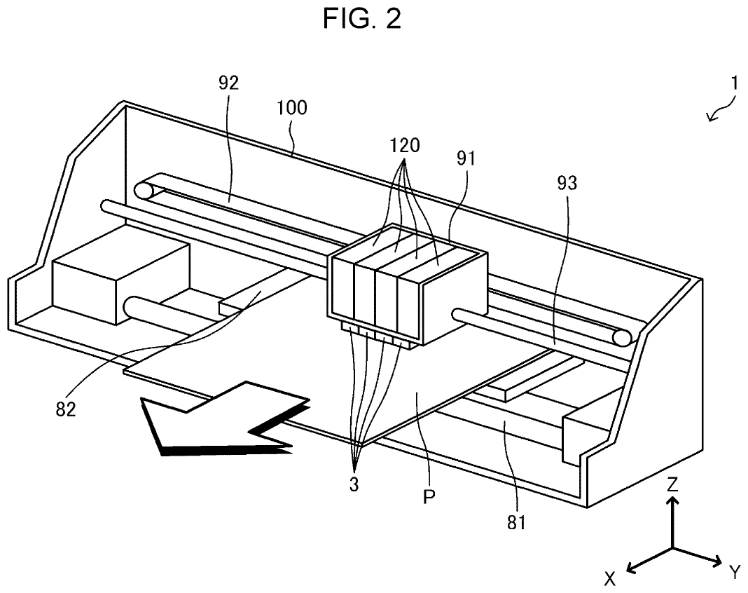

Next, an outline of a structure of the liquid ejecting apparatus 1 will be described. FIG. 2 is a diagram illustrating an example of a schematic internal structure of the liquid ejecting apparatus 1. As illustrated in FIG. 2, it is assumed that the liquid ejecting apparatus 1 according to the present embodiment is a serial type ink jet printer. That is, in the ejection process, the liquid ejecting apparatus 1 ejects ink from the head unit 3 while transporting a medium P such as recording paper along a sub-scanning direction and causing the carriage 91 on which the head unit 3 is mounted to reciprocate along a main scanning direction intersecting the sub-scanning direction. In this case, the ink ejected from the head unit 3 lands on a desired position on the medium P, and thus a dot based on the image data signal IMG is formed on the medium P. The liquid ejecting apparatus 1 is not limited to the serial type ink jet printer, and may be a line type ink jet printer.

In the following description, an X axis, a Y axis, and a Z axis that are orthogonal to each other are used. In addition, in the following description, a starting point side of an arrow indicating a direction along the X axis illustrated in FIG. 2 may be referred to as a −X side, and a tip side of the arrow may be referred to as a +X side. A starting point side of an arrow indicating a direction along the Y axis illustrated in FIG. 2 may be referred to as a −Y side, and a tip side of the arrow may be referred to as a +Y side. A starting point side of an arrow indicating a direction along the Z axis illustrated in FIG. 2 may be referred to as a −Z side, and a tip side of the arrow may be referred to as a +Z side. As illustrated in FIG. 2, in the liquid ejecting apparatus 1 according to the present embodiment, the sub-scanning direction extends along the X axis, the main scanning direction extends along the Y axis, the medium P is transported along the X axis such that the −X side is the upstream and the +X side is the downstream, and the carriage 91 is configured to reciprocate along the Y axis.

As illustrated in FIG. 2, the liquid ejecting apparatus 1 includes a housing 100 and the carriage 91 which can reciprocate in the Y-axis direction in the housing 100 and on which one or a plurality of head units 3 are mounted. In addition, on the carriage 91, four ink cartridges 120 corresponding to ink of four colors of cyan, magenta, yellow, and black on a one-to-one basis are mounted. In this case, as an example, it is assumed that the liquid ejecting apparatus 1 according to the present embodiment includes four head units 3 corresponding to the four ink cartridges 120 on a one-to-one basis.

The ink is supplied to M ejection sections D included in each of the four head units 3 from the corresponding ink cartridges 120. As a result, the insides of the 4M ejection sections D included in the four head units 3 are filled with the ink supplied from the corresponding ink cartridges 120. Then, the 4M ejection sections D included in the four head units 3 and filled with the ink eject the ink onto the medium P. The ink cartridges 120 may not be mounted on the carriage 91 and may be disposed outside the carriage 91.

The liquid ejecting apparatus 1 according to the present embodiment includes, as the carriage moving unit 9, a carriage transport mechanism 92 that causes the carriage 91 to reciprocate along the Y axis, and a carriage guide shaft 93 that supports the carriage 91 so as to enable the carriage 91 to reciprocate in the direction along the Y axis. The liquid ejecting apparatus 1 includes, as the transport unit 8, a medium transport mechanism 81 that transports the medium P, and a platen 82 disposed on the −Z side of the carriage 91. When the ejection process is executed, the carriage 91 on which the head unit 3 is mounted reciprocates along the Y axis and along the carriage guide shaft 93 by the carriage transport mechanism 92, and the medium P is transported from the −X side to the +X side along the X axis on the platen 82 by the medium transport mechanism 81. As a result, the relative position of the medium P to the head unit 3 is changed, and the ink can land on the entire medium P.

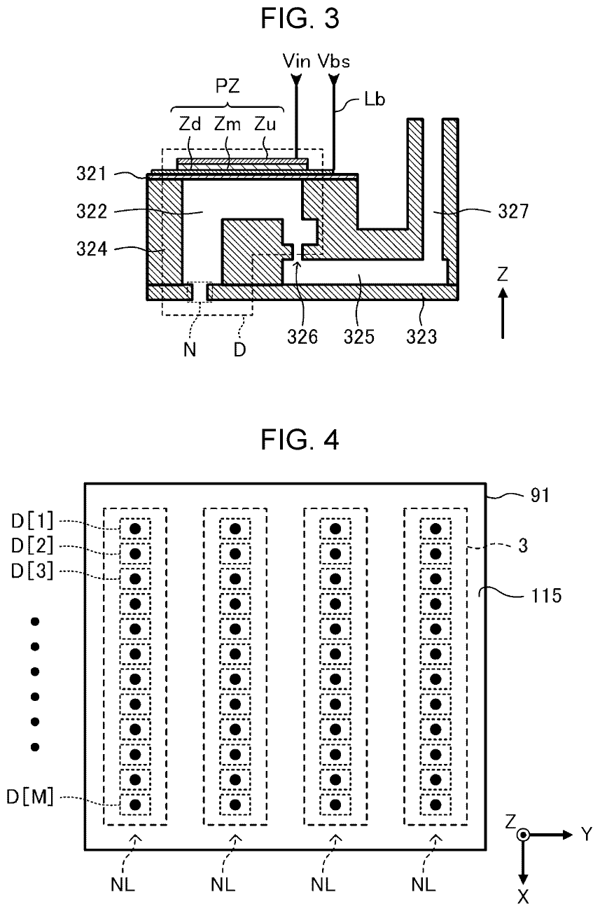

An example of a structure of one of the plurality of ejection sections D that eject the ink onto the medium P will be described. FIG. 3 is a diagram illustrating a schematic structure of the ejection section D. As illustrated in FIG. 3, the ejection section D includes a piezoelectric element PZ, a cavity 322 that is filled with ink, a nozzle N communicating with the cavity 322, and a vibration plate 321. In the ejection section D, the piezoelectric element PZ is driven when the supply drive signal VIN is supplied to the piezoelectric element PZ. The ink stored in the cavity 322 is ejected from the nozzle N by the driving of the piezoelectric element PZ.

The cavity 322 is a space defined by a cavity plate 324, a nozzle plate 323 in which the nozzle N is formed, and the vibration plate 321. The cavity 322 communicates with a reservoir 325 via an ink supply port 326, and the reservoir 325 communicates with the ink cartridge 120 corresponding to the ejection section D via an ink intake port 327. Accordingly, the ink is supplied from the corresponding ink cartridge 120 into the cavity 322 through the ink intake port 327, the reservoir 325, and the ink supply port 326. Therefore, the inside of the cavity 322 is filled with the ink supplied from the corresponding ink cartridge 120.

The piezoelectric element PZ has an upper electrode Zu, a lower electrode Zd, and a piezoelectric body Zm. The piezoelectric body Zm is located between the upper electrode Zu and the lower electrode Zd. The supply drive signal VIN output from the supply switching circuit 31 is supplied to the upper electrode Zu. The reference voltage signal VBS propagated through the wiring Lb is supplied to the lower electrode Zd. The piezoelectric body Zm is deformed toward the +Z side or the −Z side along the Z axis in accordance with the difference in electrical potential between the upper electrode Zu and the lower electrode Zd, that is, the difference between the voltage value of the supply drive signal VIN supplied to the upper electrode Zu and the voltage value of the reference voltage signal VBS supplied to the lower electrode Zd. That is, the piezoelectric element PZ is driven so as to be deformed toward the +Z side or the −Z side along the Z axis in accordance with the difference between the voltage value of the supply drive signal VIN and the voltage value of the reference voltage signal VBS. In this case, the reference voltage signal VBS supplied to the lower electrode Zd is a signal serving as a reference electrical potential for driving the piezoelectric element PZ, and an electrical potential of the reference voltage signal VBS is constant at 5.5 V or 6 V, the ground electrical potential, or the like.

The lower electrode Zd is bonded to the vibration plate 321. Therefore, when the piezoelectric element PZ is driven by the supply drive signal VIN so as to be deformed along the Z axis, the vibration plate 321 is also deformed along the Z axis. An internal volume and an internal pressure of the cavity 322 are changed by the deformation of the vibration plate 321. Then, the ink with which the inside of the cavity 322 is filled is ejected from the nozzle N in response to the changes in the internal volume and the internal pressure of the cavity 322. That is, the ink in an amount corresponding to an amount by which the piezoelectric element PZ is driven is ejected from the nozzle N of the ejection section D. In other words, the piezoelectric element PZ causes the ejection section D to eject the ink in an amount corresponding to the deformation caused by the supply of the supply drive signal VIN corresponding to the drive signal COM. That is, the ejection section D includes the piezoelectric element PZ that is driven by the drive signal COM, and ejects the ink by the driving of the piezoelectric element PZ. In other words, the liquid ejecting apparatus 1 includes the ejection section D that ejects the ink that is an example of liquid.

FIG. 4 is a diagram illustrating an example of an arrangement of the 4M ejection sections D disposed in the four head units 3 and 4M nozzles N included in the 4M ejection sections D. As illustrated in FIG. 4, the four head units 3 are arranged side by side along the Y axis in the carriage 91. In this case, the four head units 3 are arranged such that the M ejection sections D and the nozzles N included in each of the four head units 3 are located side by side along the X axis. Specifically, the ejection sections D[1] to D[M] that are the M ejection sections D included in each of the head units 3 are arranged adjacent to each other in the order of the ejection section D[1], the ejection section D[2], the ejection section D[3], . . . , and the ejection section D[M] from the −X side to the +X side along the X axis. That is, each of the head units 3 includes a nozzle row NL formed by arranging the M nozzles N included in the M ejection sections D side by side from the −X side to the +X side along the X axis. Therefore, the four nozzle rows NL included in the four head units 3 are formed along the Y axis in the carriage 91. The ink is ejected from each of the nozzles N forming the nozzle row NL included in each of the four head units 3. In the following description, a surface in which the plurality of nozzle rows NL are formed in the plurality of head units 3 mounted on the carriage 91, and which is positioned to face the medium P, and from which the ink is ejected toward the medium P may be referred to as an ejection surface 115.

That is, the liquid ejecting apparatus 1 according to the present embodiment includes the head unit 3 including the recording head 32 having the plurality of ejection sections D including the ejection section D[1] that ejects ink by driving of the piezoelectric element PZ[1] and the ejection section D[m] that ejects ink by driving of the piezoelectric element PZ[m].

### 2. Configuration and Operation of Drive Circuit

Next, a configuration and an operation of the drive circuit 50 included in the drive circuit unit 5 will be described. As described above, the drive circuit 50 generates and outputs the drive signal COM by amplifying the signal waveform defined by the drive waveform specifying signal dCOM.

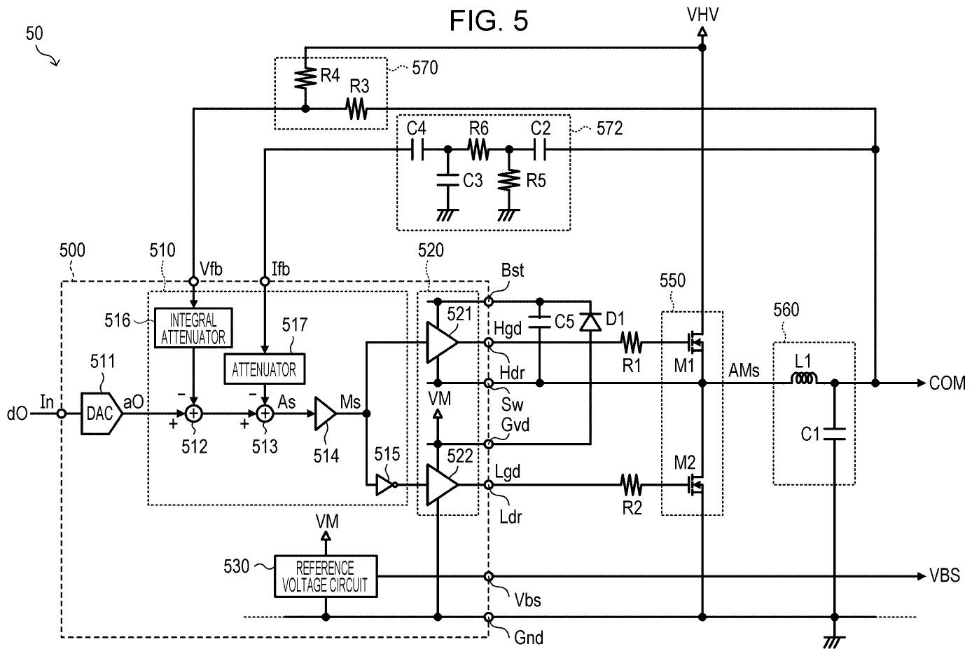

FIG. 5 is a diagram illustrating an example of the configuration of the drive circuit 50. As illustrated in FIG. 5, the drive circuit 50 includes an integrated circuit 500, an amplifier circuit 550, a demodulation circuit 560, feedback circuits 570 and 572, and a plurality of other circuit elements. The integrated circuit 500 generates a gate signal Hgd and a gate signal Lgd based on the drive waveform specifying signal dCOM and outputs the gate signal Hgd and the gate signal Lgd to the amplifier circuit 550. The amplifier circuit 550 includes transistors M1 and M2. The transistors M1 and M2 are driven based on the gate signals Hgd and Lgd, whereby the amplifier circuit 550 generates an amplified modulated signal AMs and outputs the amplified modulated signal AMs to the demodulation circuit 560. The demodulation circuit 560 demodulates the amplified modulated signal AMs by smoothing the amplified modulated signal AMs. The signal demodulated by the demodulation circuit 560 is output from the drive circuit 50 and the drive circuit unit 5 as the drive signal COM.

The integrated circuit 500 includes a plurality of terminals including a terminal In, a terminal Bst, a terminal Hdr, a terminal Sw, a terminal Gvd, a terminal Ldr, a terminal Gnd, a terminal Ifb, a terminal Vfb, and a terminal Vbs. The integrated circuit 500 is electrically coupled to an external circuit via the plurality of terminals. In addition, the integrated circuit 500 includes a digital-to-analog converter (DAC) 511, a modulation circuit 510, and a gate drive circuit 520.

The DAC 511 converts the drive waveform specifying signal dCOM, which is a digital signal that defines the signal waveform of the drive signal COM, into a base drive waveform signal aO, which is an analog signal, and outputs the base drive waveform signal aO to the modulation circuit 510. A signal obtained by amplifying the base drive waveform signal aO output by the DAC 511 corresponds to the drive signal COM. That is, the base drive waveform signal aO is an analog signal that is a target before the amplification of the drive signal COM, and the drive waveform specifying signal dCOM is a digital signal that is a target before the amplification of the drive signal COM and defines the shape of the signal waveform of the drive signal COM. The voltage amplitude of the base drive waveform signal aO output by the DAC 511 is set to be, for example, in a range of 1 V to 2 V.

The modulation circuit 510 generates a modulated signal Ms by modulating the base drive waveform signal aO, and outputs the modulated signal Ms to the gate drive circuit 520. The modulation circuit 510 includes adders 512 and 513, a comparator 514, an inverter 515, an integral attenuator 516, and an attenuator 517.

The integration attenuator 516 attenuates and integrates the voltage value of the drive signal COM input through the terminal Vfb, and outputs the integrated signal to a negative input terminal of the adder 512. The base drive waveform signal aO is input to a positive input terminal of the adder 512. The adder 512 generates a signal having a voltage value obtained by subtracting the voltage value of the signal input to the negative input terminal from the voltage value of the signal input to the positive input terminal and integrating the result of the subtraction, and outputs the generated signal to a positive input terminal of the adder 513. While the maximum value of the voltage amplitude of the base drive waveform signal aO is about 2 V as described above, the maximum voltage value of the drive signal COM may exceed 40 V. To obtain a deviation, the integral attenuator 516 attenuates the drive signal COM input through the terminal Vfb in order to match the range of the voltage amplitude of the base drive waveform signal aO and the range of the voltage amplitude of the drive signal COM.

The attenuator 517 supplies a voltage obtained by attenuating a high-frequency component of the drive signal COM input through the terminal Ifb to a negative input terminal of the adder 513. The signal output by the adder 512 is input to the positive input terminal of the adder 513. The adder 513 generates a voltage signal As by subtracting the voltage value of a signal input to the negative input terminal from the voltage value of the signal input to the positive input terminal, and outputs the voltage signal As to the comparator 514. The voltage signal As is obtained by subtracting the voltage value of the signal supplied to the terminal Vfb from the voltage value of the base drive waveform signal aO, and further subtracting, from the result of the subtraction, the voltage value of the signal supplied to the terminal Ifb. Therefore, the voltage signal As is obtained by correcting, with the high-frequency component of the drive signal COM, the deviation obtained by subtracting the attenuated voltage of the drive signal COM from the voltage value of the target base drive waveform signal aO.

The comparator 514 performs pulse modulation on the voltage signal As and outputs the pulse-modulated signal as the modulated signal Ms. Specifically, the comparator 514 outputs the modulated signal Ms that is at an H level when the voltage value of the voltage signal As is greater than or equal to a predetermined threshold Vth1 in a period of time when the voltage value of the voltage signal As increases, and is at an L level when the voltage value of the voltage signal As is less than a predetermined threshold Vth2 in a period of time when the voltage value of the voltage signal As decreases. The thresholds Vth1 and Vth2 are set such that the threshold Vth1 is greater than the threshold Vth2. The frequency and duty ratio of the modulated signal Ms change in accordance with the drive waveform specifying signal dCOM and the base drive waveform signal aO. That is, the amounts of changes in the frequency and the duty ratio of the modulated signal Ms can be adjusted by adjusting a modulation gain corresponding to the sensitivity of the attenuator 517.

The modulated signal Ms is input to a gate driver 521 included in the gate drive circuit 520. In addition, after the logic level of the modulated signal Ms is inverted by the inverter 515, the inverted modulated signal Ms is input to a gate driver 522 included in the gate drive circuit 520. That is, the signals whose logic levels are mutually exclusive are input to the gate driver 521 and the gate driver 522.

The timing of inputting the signals to the gate drivers 521 and 522 may be controlled such that the logic levels of the signals are not an H level at the same time. That is, the state where the “logic levels are mutually exclusive” indicates that the logic level of the signal input to the gate driver 521 and the logic level of the signal input to the gate driver 522 are not an H level at the same time, and includes a state where the logic level of the signal input to the gate driver 521 and the logic level of the signal input to the gate driver 522 are an L level at the same time.

The gate drive circuit 520 includes the gate driver 521 and the gate driver 522.

The gate driver 521 generates the gate signal Hgd by level-shifting the modulated signal Ms output by the comparator 514 and outputs the gate signal Hgd from the integrated circuit 500 through the terminal Hdr. As a power supply voltage of the gate driver 521, a high electrical potential is supplied to the gate driver 521 through the terminal Bst on the high electrical potential side, and a low electrical potential is supplied to the gate driver 521 through the terminal Sw on the low electrical potential side. The terminal Bst is electrically coupled to a first end of a capacitor C5 and a cathode of a diode Dl. A second end of the capacitor C5 is electrically coupled to the terminal Sw. An anode of the diode Dl is electrically coupled to the terminal Gvd. A voltage signal VM with a direct current voltage of, for example, 7.5 V generated by a power supply circuit (not illustrated) is supplied to the terminal Gvd. As a result, the difference in electrical potential between the terminal Bst and the terminal Sw is the difference in electrical potential between both ends of the capacitor C5, and is approximately equal to the voltage value of the voltage signal VM. Therefore, the gate driver 521 generates the gate signal Hgd in accordance with the logic level of the input modulated signal Ms such that the voltage value of the gate signal Hgd at an H level is greater than the voltage value of the terminal Sw by the voltage value of the voltage signal VM and that the voltage value of the gate signal Hgd at an L level is equal to the voltage value of the terminal Sw. Then, the gate driver 521 and outputs the generated gate signal Hgd from the terminal Hdr.

The gate driver 522 operates on the lower electrical potential side of the gate driver 521. The gate driver 522 generates the gate signal Lgd by level-shifting the signal obtained by inverting the logic level of the modulated signal Ms output by the comparator 514 by the inverter 515, and outputs the gate signal Lgd from the integrated circuit 500 through the terminal Ldr. As a power supply voltage of the gate driver 522, the voltage signal VM is supplied to the gate driver 522 on the high electrical potential side, and the ground electrical potential is supplied to the gate driver 522 through the terminal Gnd on the low electrical potential side. Then, the gate driver 522 generates the gate signal Lgd having the ground electrical potential in accordance with the logic level of the input signal such that the voltage value of the gate signal Lgd at an H level is greater than the voltage value of the terminal Gnd by the voltage value of the voltage signal VM and that the voltage value of the gate signal Lgd at an L level is equal to voltage value of the terminal Gnd. Then, the gate driver 522 outputs the generated gate signal Lgd from the terminal Ldr.

As described above, the gate signal Hgd is obtained by level-shifting the voltage value of the modulated signal Ms, and the gate signal Lgd is obtained by inverting the logic level of the modulated signal Ms and level-shifting the voltage value of the inverted signal. Considering the above-described feature, the gate signal Hgd and the gate signal Lgd output by the gate drive circuit 520 can also be regarded as signals obtained by modulating the drive waveform specifying signal dCOM and the base drive waveform signal aO.

The amplifier circuit 550 includes the pair of transistors M1 and M2 which are semiconductor elements such as N-type field effect transistors (FETs).

A voltage signal VHV with, for example, a direct current voltage of 42 V is supplied to a drain terminal of the transistor M1. The voltage value of the voltage signal VHV may be greater than the maximum voltage value of the drive signal COM output by the drive circuit 50 and the drive circuit unit 5, and is not limited to 42 V. A gate terminal of the transistor M1 is electrically coupled to a first end of a resistor R1. A second end of the resistor R1 is electrically coupled to the terminal Hdr of the integrated circuit 500. That is, the gate signal Hgd output by the integrated circuit 500 is input to the gate terminal of the transistor M1. A source terminal of the transistor M1 is electrically coupled to the terminal Sw of the integrated circuit 500. A conduction state between the drain terminal and the source terminal of the transistor M1 is controlled by the gate signal Hgd input to the gate terminal of the transistor M1.

A drain terminal of the transistor M2 is electrically coupled to the terminal Sw of the integrated circuit 500. That is, the drain terminal of the transistor M2 and the source terminal of the transistor M1 are electrically coupled to each other. A gate terminal of the transistor M2 is electrically coupled to a first end of a resistor R2. A second end of the resistor R2 is electrically coupled to the terminal Ldr of the integrated circuit 500. That is, the gate signal Lgd output by the integrated circuit 500 is input to the gate terminal of the transistor M2. The ground electrical potential is supplied to a source terminal of the transistor M2. A conduction state between the drain terminal and the source terminal of the transistor M2 is controlled by the gate signal Lgd input to the gate terminal of the transistor M2.

In the following description, the transistors M1 and M2 that are controlled to be conductive between the drain terminals and the source terminals of the transistors M1 and M2 may be referred to as the transistors M1 and M2 being controlled to be on, and the transistors M1 and M2 that are controlled to be non-conductive between the drain terminals and the source terminals of the transistors M1 and M2 may be referred to as the transistors M1 and M2 being controlled to be off.

In the amplifier circuit 550 configured as described above, when the transistor M1 is controlled to be off and the transistor M2 is controlled to be on, a node to which the terminal Sw is coupled becomes the ground electrical potential. In this case, the voltage signal VM is supplied to the terminal Bst. On the other hand, when the transistor M1 is controlled to be on and the transistor M2 is controlled to be off, the node to which the terminal Sw is coupled becomes the voltage signal VHV. Therefore, a signal having a voltage value that is the sum of the voltage value of the voltage signal VHV and the voltage value of the voltage signal VM is supplied to the terminal Bst. That is, the gate driver 521 that drives the transistor M1 uses the capacitor C5 as a floating power source, and the electrical potential of the second end of the capacitor C5, that is, the electrical potential of the terminal Sw changes to the ground electrical potential or the voltage value of the voltage signal VHV in accordance with the operations of the transistor M1 and the transistor M2, whereby the gate driver 521 generates the gate signal Hgd such that the voltage value of the gate signal Hgd at an L level is equal to the voltage value of the voltage signal VHV and that the voltage value of the gate signal Hgd at an H level is equal to the sum of the voltage value of the voltage signal VHV and the voltage value of the voltage signal VM, and supplies the gate signal Hgd to the gate terminal of the transistor M1.

On the other hand, the gate driver 522 that drives the transistor M2 generates the gate signal Lgd such that the voltage value of the gate signal Lgd at an L level is equal to the ground electrical potential and that the voltage value of the gate signal Lgd at an H level is equal to the voltage value of the voltage signal VM regardless of the operations of the transistor M1 and the transistor M2, and supplies the gate signal Lgd to the gate terminal of the transistor M2.

As described above, the transistors M1 and M2 operate in accordance with the gate signals Hgd and Lgd, and thus the amplifier circuit 550 amplifies, based on the voltage signal VHV, the drive waveform specifying signal dCOM and the modulated signal Ms obtained by modulating the base drive waveform signal aO. Then, the amplifier circuit 550 outputs the amplified signal as the amplified modulated signal AMs from a coupling point where the source terminal of the transistor M1 and the drain terminal of the transistor M2 are commonly coupled.

The demodulation circuit 560 demodulates the amplified modulated signal AMs by smoothing the amplified modulated signal AMs so as to generate the drive signal COM. Then, the demodulation circuit 560 outputs the generated drive signal COM from the drive circuit 50.

The demodulation circuit 560 includes a coil Li and a capacitor C1. A first end of the coil Li is electrically coupled to the source terminal of the transistor M1 and the drain terminal of the transistor M2. Therefore, the amplified modulated signal AMs is input to the first end of the coil Li. A second end of the coil Li is coupled to a first end of the capacitor C1. The ground electrical potential is supplied to a second end of the capacitor C1. That is, the coil Li and the capacitor C1 constitute a low-pass filter. Then, the amplified modulated signal AMs is smoothed by the low-pass filter disposed in the demodulation circuit 560, and thus the drive signal COM is generated at a coupling point where the second end of the coil Li and the first end of the capacitor C1 are electrically coupled.

The feedback circuit 570 includes a resistor R3 and a resistor R4. The drive signal COM is supplied to a first end of the resistor R3, and a second end of the resistor R3 is coupled to the terminal Vfb and a first end of the resistor R4. The voltage signal VHV is supplied to a second end of the resistor R4. As a result, the drive signal COM that has passed through the feedback circuit 570 is fed back to the terminal Vfb in a pulled-up state.

The feedback circuit 572 includes capacitors C2, C3, and C4 and resistors R5 and R6. The drive signal COM is supplied to a first end of the capacitor C2, and a second end of the capacitor C2 is coupled to a first end of the resistor R5 and a first end of the resistor R6. The ground electrical potential is supplied to a second end of the resistor R5. Thus, the capacitor C2 and the resistor R5 function as a high-pass filter.

A second end of the resistor R6 is coupled to a first end of the capacitor C4 and a first end of the capacitor C3. The ground electrical potential is supplied to a second end of the capacitor C3. Thus, the resistor R6 and the capacitor C3 function as a low-pass filter.

As described above, the feedback circuit 572 includes the high-pass filter and the low-pass filter. Therefore, the feedback circuit 572 functions as a band pass filter that passes a predetermined frequency component of the drive signal COM. A second end of the capacitor C4 included in the feedback circuit 572 is coupled to the terminal Ifb of the integrated circuit 500. Accordingly, a signal obtained by removing a direct-current component from the high-frequency component of the drive signal COM that has passed through the feedback circuit 572 is fed back to the terminal Ifb. The feedback circuit 572 functions as the band pass filter that passes the predetermined frequency component.

As described above, the drive signal COM output by the drive circuit 50 is obtained by the demodulation circuit 560 demodulating the amplified modulated signal AMs based on the drive waveform specifying signal dCOM by smoothing the amplified modulated signal AMs. The drive signal COM output by the demodulation circuit 560 passes through the feedback circuit 570 and the terminal Vfb, is integrated and attenuated by the integral attenuator 516, and is fed back to the adder 512. As a result, the drive circuit 50 self-oscillates at a frequency determined by a delay in the feedback and a transfer function for the feedback. However, since the delay amount is large only in a feedback path through the terminal Vfb, the frequency of self-oscillation may not be increased to such an extent that the accuracy of the drive signal COM can be sufficiently secured only by the feedback through the terminal Vfb.

The drive circuit 50 according to the present embodiment has a path for feeding back the high-frequency component of the drive signal COM through the feedback circuit 572 and the terminal Ifb, separately from the path through the terminal Vfb. Accordingly, in the drive circuit 50 according to the present embodiment, it is possible to reduce a delay in the entire circuit, and it is possible to increase the frequency of the voltage signal As to such an extent that the accuracy of the drive signal COM can be sufficiently secured, compared to a case where the path through the terminal Ifb does not exist. As a result, the accuracy of the waveform of the drive signal COM is improved.

That is, the drive circuit 50 includes the class-D amplifier circuit, and outputs the drive signal COM to be supplied to the upper electrode Zu[1] that is a first end of the piezoelectric element PZ[1] and to the upper electrode Zu[m] that is a first end of the piezoelectric element PZ[m].

As illustrated in FIG. 5, the integrated circuit 500 of the drive circuit 50 includes a reference voltage circuit 530. The reference voltage circuit 530 generates the reference voltage signal VBS by stepping down the voltage value of the voltage signal VM, and outputs the reference voltage signal VBS from the drive circuit 50 and the drive circuit unit 5 through the terminal Vbs of the integrated circuit 500.

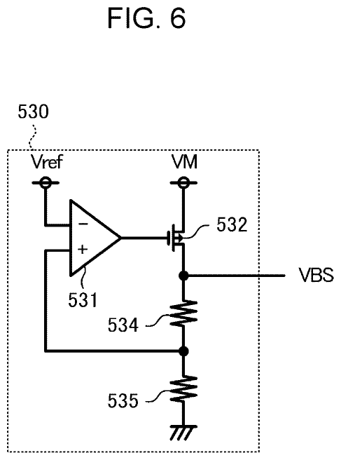

FIG. 6 is a diagram illustrating an example of a configuration of the reference voltage circuit 530. The reference voltage circuit 530 includes a comparator 531, a transistor 532, and resistors 534 and 535. In the following description, it is assumed that the transistor 532 is a PMOS transistor.

A reference voltage Vref is supplied to a negative input terminal of the comparator 531. The reference voltage Vref can be generated based on, for example, a band gap reference voltage of the integrated circuit 500. A positive input terminal of the comparator 531 is electrically coupled to a first end of the resistor 534 and a first end of the resistor 535. An output terminal of the comparator 531 is electrically coupled to a gate terminal of the transistor 532. The voltage signal VM is supplied to a source terminal of the transistor 532. A drain terminal of the transistor 532 is electrically coupled to a second end of the resistor 534. The ground electrical potential is supplied to a second end of the resistor 535. Then, the reference voltage circuit 530 outputs the reference voltage signal VBS from a coupling point where the drain terminal of the transistor 532 and the second end of the resistor 534 are electrically coupled.

In the reference voltage circuit 530 configured as described above, in a case where a voltage value supplied to the positive input terminal of the comparator 531 is greater than the voltage value of the reference voltage Vref supplied to the negative input terminal of the comparator 531, the comparator 531 outputs an H-level signal. In this case, the transistor 532 is controlled to be turned off. Therefore, the voltage signal VM is not supplied to the coupling point where the drain terminal of the transistor 532 and the second end of the resistor 534 are electrically coupled. On the other hand, in a case where the voltage value supplied to the positive input terminal of the comparator 531 is less than the voltage value of the reference voltage Vref supplied to the negative input terminal of the comparator 531, the comparator 531 outputs an L-level signal. In this case, the transistor 532 is controlled to be turned on. Therefore, the voltage signal VM is supplied to the coupling point where the drain terminal of the transistor 532 and the second end of the resistor 534 are electrically coupled.

That is, in the reference voltage circuit 530, the comparator 531 and the transistor 532 operate such that the voltage value of the coupling point where the drain terminal of the transistor 532 and the second end of the resistor 534 are electrically coupled, that is, the voltage value obtained by dividing the voltage value of the reference voltage signal VBS by the resistors 534 and 535 is equal to the voltage value of the reference voltage Vref, and thus the reference voltage circuit 530 generates and outputs the reference voltage signal VBS having a constant voltage value. In other words, the reference voltage circuit 530 generates the reference voltage signal VBS having the constant voltage value by stepping down the voltage value of the voltage signal VM, and outputs the reference voltage signal VBS from the drive circuit 50 and the drive circuit unit 5 through the terminal Vbs of the integrated circuit 500.

That is, the drive circuit unit 5 includes the reference voltage circuit 530 that outputs the reference voltage signal VBS to be supplied to the lower electrode Zd[1] that is a second end of the piezoelectric element PZ[1] and to the lower electrode Zd[m] that is a second end of the piezoelectric element PZ[m].

The reference voltage circuit 530 may be disposed separately from the drive circuit unit 5. In this case, some or all of circuit elements of the reference voltage circuit 530 may be disposed as discrete components outside the integrated circuit 500. However, as illustrated in FIG. 5, it is preferable that all of the circuit elements of the reference voltage circuit 530 be disposed in the integrated circuit 500. Accordingly, the drive circuit unit 5 including the drive circuit 50 and the reference voltage circuit 530, and the liquid ejecting apparatus 1 including the drive circuit unit 5 can be made compact.

### 3. Configuration and Operation of Sink Circuit

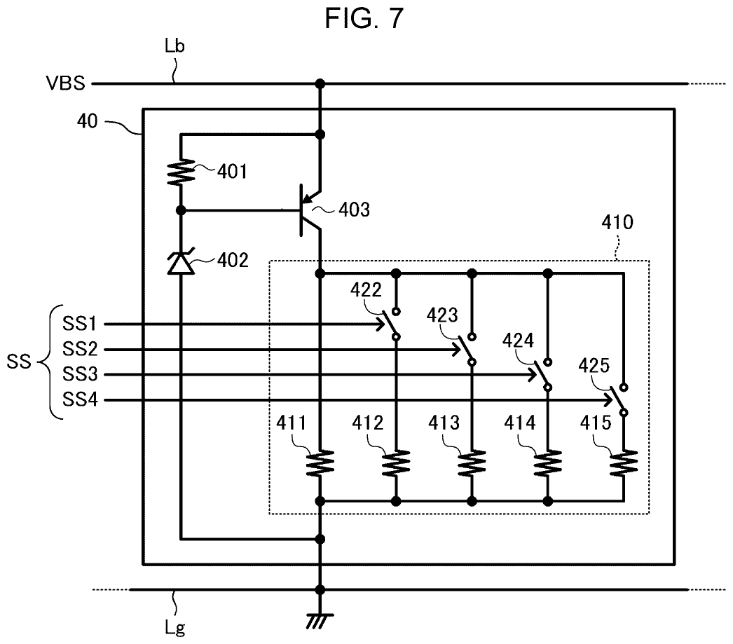

Next, a configuration and an operation of the sink circuit 40 included in the sink unit 4 will be described. FIG. 7 is a diagram illustrating an example of the configuration of the sink circuit 40. As described above, based on the voltage value of the reference voltage signal VBS, the sink circuit 40 releases, with the sink capability defined by the sink control signal SS, electrical charge of the wiring Lb, through which the reference voltage signal VBS propagates, to the wiring Lg, through which the ground electrical potential propagates. The sink capability corresponds to the amount of electrical charge that can be released from the wiring, through which the reference voltage signal VBS propagates, to the wiring, through which the ground electrical potential propagates, and corresponds to the amount of current that can flow from the wiring, through which the reference voltage signal VBS propagates, toward the wiring, through which the ground electrical potential propagates. In the following description, a high sink capability indicates that the amount of electrical charge that can be released from the wiring, through which the reference voltage signal VBS propagates, to the wiring, through which the ground electrical potential propagates, and the amount of current that can flow from the wiring, through which the reference voltage signal VBS propagates, toward the wiring, through which the ground electrical potential propagates, are large. A low sink capability indicates that the amount of electrical charge that can be released from the wiring, through which the reference voltage signal VBS propagates, to the wiring, through which the ground electrical potential propagates, and the amount of current that can flow from the wiring, through which the reference voltage signal VBS propagates, toward the wiring, through which the ground electrical potential propagates, are small.

If a short-circuit abnormality occurs in one or more of the piezoelectric elements PZ D[1] to PZ[M] included in the ejection sections D[1] to D[M], for example, if a short-circuit abnormality occurs in the piezoelectric element PZ[m], the amount of current flowing into the wiring Lb through the piezoelectric element PZ[m] in which the short-circuit abnormality occurs increases. As the amount of current propagating through the wiring Lb increases, the voltage value of the reference voltage signal VBS that is the voltage value of the signal propagating through the wiring Lb increases. Thereafter, when the voltage value of the reference voltage signal VBS exceeds a predetermined detection threshold at which an overvoltage protection function (not illustrated) included in the liquid ejecting apparatus 1 operates, the liquid ejecting apparatus 1 stops operating.

Meanwhile, the liquid ejecting apparatus 1 has a so-called complementing function of complementing a dot which may be originally formed on the medium P by ink ejected from the ejection section D[m] with a dot formed by ink ejected from at least one of the ejection section D[m+1] and the ejection section D[m−1] that are located adjacent to the ejection section D[m] when ink is not ejected from the ejection section D[m]. In the liquid ejecting apparatus 1 having the complementing function, when the liquid ejecting apparatus 1 stops operating due to a short-circuit abnormality occurring in a small number of piezoelectric elements PZ among the piezoelectric elements PZ[1] to PZ[M], the liquid ejecting apparatus 1 stops operating regardless of the fact that it is possible to form, on the medium P, the image based on the image data signal IMG, and as a result, there is a possibility that the productivity of the liquid ejecting apparatus 1 may be reduced.

To address the above-described issue, the sink circuit 40 has a sink function of releasing electrical charge of the wiring Lb to the wiring Lg through which the ground electrical potential propagates when the voltage value of the reference voltage signal VBS that is the voltage value of the signal propagating through the wiring Lb exceeds a predetermined voltage value. Accordingly, the sink circuit 40 reduces the possibility that the voltage value of the reference voltage signal VBS that is the voltage value of the signal propagating through the wiring Lb may increase, and reduces the possibility that the operation of the liquid ejecting apparatus 1 may stop operating due to a short-circuit abnormality occurring in a small number of piezoelectric elements PZ among the piezoelectric elements PZ[1] to PZ[M]. As a result, even if a short-circuit abnormality occurs in a small number of piezoelectric elements PZ among the piezoelectric elements PZ[1] to PZ[M] included in the ejection sections D[1] to D[M], it is possible to reduce the possibility that the productivity in the liquid ejecting apparatus 1 may be reduced.

Meanwhile, the voltage value of the reference voltage signal VBS that is the voltage value of the signal propagating through the wiring Lb may increase due to a cause other than a short-circuit abnormality of the piezoelectric element PZ[m], for example, an operation abnormality of the reference voltage circuit 530, a short-circuit abnormality between a plurality of wiring patterns including the wiring Lb, or interference of external noise. In such a case, the liquid ejecting apparatus 1 is preferably stopped from the viewpoint of the stability of the operation. However, since the possibility that the voltage value of the reference voltage signal VBS that is the voltage value of the signal propagating through the wiring Lb may increase is reduced by the operation of the sink function of the sink circuit 40, the increase in the voltage value may not be detected by the overvoltage protection function of the liquid ejecting apparatus 1 described above. In a case where the liquid ejecting apparatus 1 continues operating in such a state, there is a possibility that the quality of an image formed on the medium P in the liquid ejecting apparatus 1 may be reduced.

As described above, the sink circuit 40 is required to operate with a sink capability appropriate for the operation state of the liquid ejecting apparatus 1. Meanwhile, the sink circuit 40 included in the liquid ejecting apparatus 1 according to the present embodiment can control the sink capability in accordance with the sink control signal SS output by the control unit 2, and thus can operate with a sink capability appropriate for the operation state of the liquid ejecting apparatus 1. As a result, it is possible to reduce the possibility that the productivity of the liquid ejecting apparatus 1 may be reduced and to reduce the possibility that the convenience of the liquid ejecting apparatus 1 may be reduced, while reducing the possibility that the quality of an image formed on the medium P by the liquid ejecting apparatus 1 may be reduced.

An example of a configuration and an operation of the sink circuit 40 will be described. FIG. 7 is a diagram illustrating an example of the configuration of the sink circuit 40. As illustrated in FIG. 7, the sink circuit 40 includes a resistor 401, a constant voltage diode 402, a transistor 403, and a variable resistance circuit 410.

The transistor 403 is a PNP-type bipolar transistor. An emitter terminal of the transistor 403 is electrically coupled to the wiring Lb through which the reference voltage signal VBS propagates. A collector terminal of the transistor 403 is electrically coupled to a first end of the variable resistance circuit 410. A base terminal of the transistor 403 is electrically coupled to a first end of the resistor 401 and a cathode terminal of the constant voltage diode 402. A second end of the resistor 401 is electrically coupled to the wiring Lb through which the reference voltage signal VBS propagates, and an anode terminal of the constant voltage diode 402 and a second end of the variable resistance circuit 410 are electrically coupled to the wiring Lg through which the ground electrical potential propagates. That is, the sink circuit 40 has a first end electrically coupled to the wiring Lb through which the reference voltage signal VBS propagates, and a second end electrically coupled to the wiring Lg through which the ground electrical potential propagates.

In the sink circuit 40 configured as described above, when the voltage value of the reference voltage signal VBS propagating through the wiring Lb is less than a breakdown voltage vz of the constant voltage diode 402, the voltage value of the cathode terminal of the constant voltage diode 402 is held at the voltage value of the reference voltage signal VBS. Therefore, the voltage value of the emitter terminal of the transistor 403 and the voltage value of the base terminal of the transistor 403 are substantially equal to each other. Therefore, when the voltage value of the reference voltage signal VBS propagating through the wiring Lb is less than the breakdown voltage vz of the constant voltage diode 402, the transistor 403 is controlled to be non-conductive between the emitter terminal and the collector terminal of the transistor 403. In this case, electrical charge of the wiring Lb through which the reference voltage signal VBS propagates is not released to the wiring Lg through which the ground electrical potential propagates. In other words, when the voltage value of the reference voltage signal VBS propagating through the wiring Lb is less than the breakdown voltage vz of the constant voltage diode 402, the sink circuit 40 does not release electrical charge of the wiring Lb.

On the other hand, when the voltage value of the reference voltage signal VBS propagating through the wiring Lb is greater than the breakdown voltage vz of the constant voltage diode 402, the voltage value of the cathode terminal of the constant voltage diode 402 is held at the breakdown voltage vz. Therefore, a difference in electrical potential that corresponds to the difference between the voltage value of the reference voltage signal VBS and the breakdown voltage vz of the constant voltage diode 402 occurs between the emitter terminal of the transistor 403 and the base terminal of the transistor 403. Then, when the difference in electrical potential is greater than a threshold voltage of the transistor 403, the transistor 403 is controlled to be conductive between the emitter terminal and the collector terminal of the transistor 403. Accordingly, electrical charge of the wiring Lb through which the reference voltage signal VBS propagates is released through the transistor 403 and the variable resistance circuit 410 toward the wiring Lg through which the ground electrical potential propagates. That is, at least a portion of the current propagating through the wiring Lb flows toward the wiring Lg through the transistor 403 and the variable resistance circuit 410. In this case, the amount of electrical charge released from the wiring Lb toward the wiring Lg, that is, the amount of the current flowing from the wiring Lb toward the wiring Lg is controlled by the resistance value between the first end and the second end of the variable resistance circuit 410. In other words, the sink capability of the sink circuit 40 can be controlled by the resistance value between the first end and the second end of the variable resistance circuit 410.

As illustrated in FIG. 7, sink control signals SS1 to SS4 as the sink control signal SS are input to the variable resistance circuit 410 that switches the sink capability of the sink circuit 40. The resistance value of the variable resistance circuit 410 is controlled by the sink control signals SS1 to SS4.

Specifically, the variable resistance circuit 410 includes resistors 411 to 415 and switches 422 to 425.

A first end of the resistor 411 is electrically coupled to the first end of the variable resistance circuit 410, and a second end of the resistor 411 is electrically coupled to the second end of the variable resistance circuit 410. A first end of the switch 422 is electrically coupled to the first end of the variable resistance circuit 410, a second end of the switch 422 is electrically coupled to a first end of the resistor 412, and a second end of the resistor 412 is electrically coupled to the second end of the variable resistance circuit 410. That is, the switch 422 and the resistor 412 are coupled in series between the first end and the second end of the variable resistance circuit 410. Further, a first end of the switch 423 is electrically coupled to the first end of the variable resistance circuit 410, a second end of the switch 423 is electrically coupled to a first end of the resistor 413, and a second end of the resistor 413 is electrically coupled to the second end of the variable resistance circuit 410. That is, the switch 423 and the resistor 413 are coupled in series between the first end and the second end of the variable resistance circuit 410. Further, a first end of the switch 424 is electrically coupled to the first end of the variable resistance circuit 410, a second end of the switch 424 is electrically coupled to a first end of the resistor 414, and a second end of the resistor 414 is electrically coupled to the second end of the variable resistance circuit 410. That is, the switch 424 and the resistor 414 are coupled in series between the first end and the second end of the variable resistance circuit 410. Further, a first end of the switch 425 is electrically coupled to the first end of the variable resistance circuit 410, a second end of the switch 425 is electrically coupled to a first end of the resistor 415, and a second end of the resistor 415 is electrically coupled to the second end of the variable resistance circuit 410. That is, the switch 425 and the resistor 415 are coupled in series between the first end and the second end of the variable resistance circuit 410. The first end of the variable resistance circuit 410 is electrically coupled to the collector terminal of the transistor 403, and the second end of the variable resistance circuit 410 is electrically coupled to the wiring Lg.

The sink control signal SS1 is input to a control terminal of the switch 422, the sink control signal SS2 is input to a control terminal of the switch 423, the sink control signal SS3 is input to a control terminal of the switch 424, and the sink control signal SS4 is input to a control terminal of the switch 425. The conduction states of the switches 422 to 425 are controlled by the sink control signals SS1 to SS4 input to the control terminals, respectively. As the switches 422 to 425, for example, PMOS transistors can be used. Therefore, the switch 422 is controlled to be non-conductive between the first end and the second end of the switch 422 in a period of time when an H-level sink control signal SS1 is input to the control terminal of the switch 422. The switch 422 is controlled to be conductive between the first end and the second end of the switch 422 in a period of time when an L-level sink control signal SS1 is input to the control terminal of the switch 422. Similarly, the switches 423 to 425 are controlled to be non-conductive between the first ends and the second ends of the switches 423 to 425 in a period of time when H-level sink control signals SS2 to SS4 are input to the control terminals of the switches 423 to 425, respectively. The switches 423 to 425 are controlled to be conductive between the first ends and the second ends of the switches 423 to 425 in a period of time when L-level sink control signals SS2 to SS4 are input to the control terminals of the switches 423 to 425, respectively.

In a period of time when the H-level sink control signals SS1 to SS4 are input to the variable resistance circuit 410 configured as described above, the resistance value between the first end and the second end of the variable resistance circuit 410 is set to the resistance value of the resistor 411. In a period of time when the H-level sink control signals SS2 to SS4 and the L-level sink control signal SS1 are input to the variable resistance circuit 410, the resistance value between the first end and the second end of the variable resistance circuit 410 is set to a combined resistance value of the resistors 411 and 412 coupled in parallel. In a period of when the H-level sink control signals SS3 and SS4 and the L-level sink control signals SS1 and SS2 are input to the variable resistance circuit 410, the resistance value between the first end and the second end of the variable resistance circuit 410 is set to a combined resistance value of the resistors 411 to 413 coupled in parallel. In a period of time when the H-level sink control signal SS4 and the L-level sink control signal SS1 to SS3 are input to the variable resistance circuit 410, the resistance value between the first end and the second end of the variable resistance circuit 410 is set to a combined resistance value of the resistors 411 to 414 coupled in parallel.

That is, the sink circuit 40 switches an impedance value between the wiring Lb through which the reference voltage signal VBS propagates and the wiring Lg through which a signal having the ground electrical potential lower than that of the reference voltage signal VBS propagates. Specifically, the sink circuit 40 has an operation mode in which the impedance value between the wiring Lb and the wiring Lg is set a resistance value in a state where the transistor 403 is non-conductive, an operation mode in which the impedance value between the wiring Lb and the wiring Lg is set to a resistance value equal to the resistance value of the resistor 411 and less than the resistance value in the state where the transistor 403 is non-conductive, an operation mode in which the impedance value between the wiring Lb and the wiring Lg is set to a resistance value that is less than the resistance value of the resistor 411 and equal to the combined resistance value of the resistors 411 and 412 coupled in parallel, an operation mode in which the impedance value between the wiring Lb and the wiring Lg is set to a resistance value that is less than the combined resistance value of the resistors 411 and 412 coupled in parallel and is equal to the combined resistance value of the resistors 411 to 413 coupled in parallel, an operation mode in which the impedance value between the wiring Lb and the wiring Lg is set to a resistance value that is less than the combined resistance value of the resistors 411 to 413 coupled in parallel and is equal to the combined resistance value of the resistors 411 to 414 coupled in parallel, and an operation mode in which the impedance value between the wiring Lb and the wiring Lg is set to a resistance value that is that is less than the combined resistance value of the resistors 411 to 414 coupled in parallel and is equal to a combined resistance value of the resistors 411 to 415 coupled in parallel.

That is, the resistance value between the first end and the second end of the variable resistance circuit 410 is controlled by the sink control signals SS1 to SS4. Therefore, the sink capability of the sink circuit 40 is controlled by the sink control signals SS1 to SS4.

In a period of time when the H level sink control signals SS1 to SS4 are input to the variable resistance circuit 410, when the transistor 403 is controlled to be conductive, the sink circuit 40 including the variable resistance circuit 410 configured as described above releases, with a sink capability corresponding to the resistance value of the resistor 411, electrical charge of the wiring Lb, through which the reference voltage signal VBS propagates, to the wiring Lg, through which the ground electrical potential propagates. In a period of time when the H-level sink control signals SS2 to SS4 and the L-level sink control signal SS1 are input to the variable resistance circuit 410, when the transistor 403 is controlled to be conductive, the sink circuit 40 releases, with a sink capability corresponding to the combined resistance value of the resistors 411 and 412 coupled in parallel, electrical charge of the wiring Lb, through which the reference voltage signal VBS propagates, to the wiring Lg, through which the ground electrical potential propagates. In a period of time when the H-level sink control signals SS3 and SS4 and the L-level sink control signals SS1 and SS2 are input to the variable resistance circuit 410, when the transistor 403 is controlled to be conductive, the sink circuit 40 releases, with a sink capability corresponding to the combined resistance value of the resistors 411 to 413 coupled in parallel, electrical charge of the wiring Lb, through which the reference voltage signal VBS propagates, to the wiring Lg, through which the ground electrical potential propagates. In a period of time when the H-level sink control signal SS4 and the L-level sink control signals SS1 to SS3 are input to the variable resistance circuit 410, when the transistor 403 is controlled to be conductive, the sink circuit 40 releases, with a sink capability corresponding to the combined resistance value of the resistors 411 to 414 coupled in parallel, electrical charge of the wiring Lb, through which the reference voltage signal VBS propagates, to the wiring Lg, through which the ground electrical potential propagates. In a period of time when the L-level sink control signals SS1 to SS4 are input to the variable resistance circuit 410, when the transistor 403 is controlled to be conductive, the sink circuit 40 releases, with a sink capability corresponding to the combined resistance value of the resistors 411 to 415 coupled in parallel, electrical charge of the wiring Lb, through which the reference voltage signal VBS propagates, to the wiring Lg, through which the ground electrical potential propagates.

Therefore, based on the voltage value of the reference voltage signal VBS propagating through the wiring Lb, the sink circuit 40 can release, with the sink capability defined by the sink control signals SS1 to SS4 as the sink control signal SS, electrical charge of the wiring Lb, through which the reference voltage signal VBS propagates, to the wiring Lg, through which the ground electrical potential propagates. In other words, the sink capability of the sink circuit 40 is controlled by the sink control signals SS1 to SS4 as the sink control signal SS.

As described above, the sink circuit 40 according to the present embodiment includes the transistor 403 and the variable resistance circuit 410, the emitter terminal of the transistor 403 that is a first end of the transistor 403 is electrically coupled to the wiring Lb, the collector terminal of the transistor 403 that is a second end of the transistor 403 is electrically coupled to the first end of the variable resistance circuit 410, and the second end of the variable resistance circuit 410 is electrically coupled to the wiring Lg.

The variable resistance circuit 410 included in the sink circuit 40 may have a configuration in which the resistance value between the first end and the second end of the variable resistance circuit 410, that is, the resistance value between the collector terminal of the transistor 403 and the wiring Lg through which the ground electrical potential propagates can be changed in accordance with the sink control signal SS. Therefore, for example, the variable resistance circuit 410 may include an integrated circuit such as a digital potentiometer. However, the variable resistance circuit 410 preferably includes a discrete component, and the sink circuit 40 preferably includes the discrete component. Accordingly, it is possible to optimally select the sizes of components of the transistor 403 and the resistors 411 to 415 based on the amount of current released from the wiring Lb by the sink circuit 40, that is, based on the sink capability of the sink circuit 40, and it is possible to increase the versatility of the sink circuit 40 and to reduce the amount of heat generation in the transistor 403 and the resistors 411 to 415.

The sink circuit 40 may include a resistance element coupled between the anode terminal of the constant voltage diode 402 and the wiring Lg. As a result, the value of a voltage held at the cathode terminal of the constant voltage diode 402 and the amount of current flowing through the constant voltage diode 402 can be controlled, and the voltage value of the wiring Lb when the transistor 403 is controlled to be conductive can be controlled in detail.

Although similar effects can be obtained as long as the sink circuit 40 is located between the wiring Lb through which the reference voltage signal VBS propagates and wiring through which a signal having an electrical potential lower than the voltage value of the reference voltage signal VBS propagates, the sink circuit 40 is preferably located between the wiring Lb through which the reference voltage signal VBS propagates and the wiring Lg through which the ground electrical potential propagates, as described in the present embodiment. As a result, the sink circuit 40 can efficiently release electrical charge from the wiring Lb.

### 4. Configuration of Head Unit

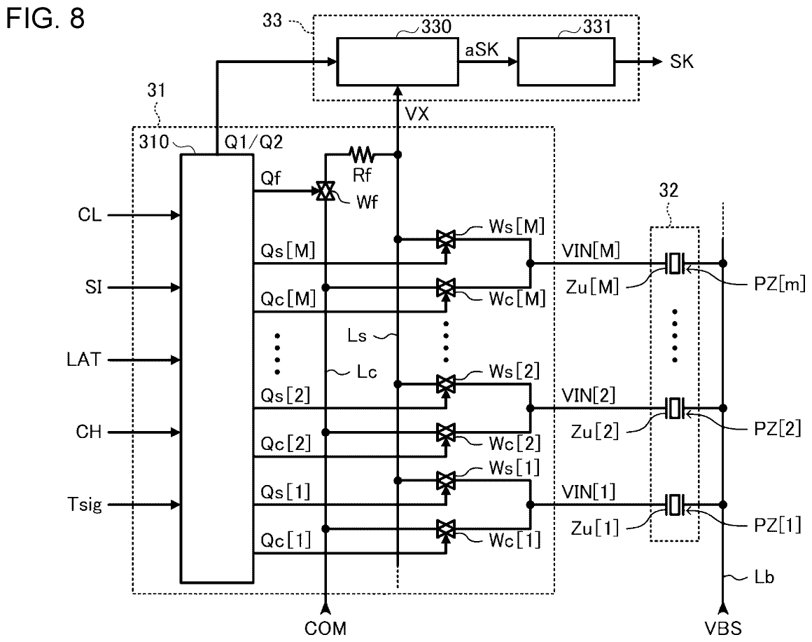

Next, a functional configuration of the head unit 3 will be described. FIG. 8 is a diagram illustrating an example of the functional configuration of the head unit 3. As described above, the head unit 3 includes the supply switching circuit 31, the recording head 32, and the detection circuit 33. FIG. 8 illustrates wiring Lc through which the drive signal COM propagates, the wiring Lb through which the reference voltage signal VBS propagates, and wiring Ls through which the detected electrical potential signal VX propagates to the detection circuit 33 in the head unit 3.

The supply switching circuit 31 includes switches Wc[1] to Wc[M], switches Ws[1] to Ws[M], a switch Wf, a resistor Rf, and a coupling state specifying circuit 310. The switches Wc[1] to Wc[M] and the switches Ws[1] to Ws[M] are disposed in the supply switching circuit 31 so as to correspond to the ejection sections D[1] to D[M]. Specifically, in the supply switching circuit 31, the switch Wc[m] and the switch Ws[m] are disposed corresponding to the ejection section D[m].

The clock signal CL, the print data signal SI, the latch signal LAT, the change signal CH, and the period specifying signal Tsig are input to the coupling state specifying circuit 310. The coupling state specifying circuit 310 generates, in accordance with the print data signal SI propagated in synchronization with the clock signal CL, signals for specifying conduction states of the switches Wc[1] to Wc[M], the switches Ws[1] to Ws[M], and the switch Wf in a period defined by the latch signal LAT, the change signal CH, and the period specifying signal Tsig that have been input to the coupling state specifying circuit 310. Thereafter, the coupling state specifying circuit 310 outputs coupling state specifying signals Qc[1] to Qc[M] obtained by level-shifting the signals specifying the conduction states of the switches Wc[1] to Wc[M] to high-amplitude logic signals, outputs coupling state specifying signals Qs[1] to Qs[M] obtained by level-shifting the signals specifying the conduction states of the switches Ws[1] to Ws[M] to high-amplitude logic signals, and outputs a coupling state specifying signal Qf obtained by level-shifting the signal specifying the conduction state of the switch Wf to a high-amplitude logic signal.

The coupling state specifying signals Qc[1] to Qc[M] output by the coupling state specifying circuit 310 are input to control terminals of the switches Wc[1] to Wc[M], the coupling state specifying signals Qs[1] to Qs[M] output by the coupling state specifying circuit 310 are input to control terminals of the switches Ws[1] to Ws[M], and the coupling state specifying signal Qf output by the coupling state specifying circuit 310 is input to a control terminal of the switch Wf. Thus, the conduction state of each of the switches Wc[1] to Wc[M], Ws[1] to Ws[M], and Wf is controlled.

The coupling state specifying circuit 310 includes, for example, a register that holds the print data signal SI propagated in synchronization with the clock signal CL in association with the ejection sections D[1] to D[M], a decoder that generates the signals specifying the conduction states of the switches Wc[1] to Wc[M], Ws[1] to Ws[M], and Wf by decoding the print data signal SI held in the register, and a level shift circuit that outputs the coupling state specifying signals Qc[1] to Qc[M], Qs[1] to Qs[M], and Qf obtained by level-shifting logics of the signals generated by the decoder to the high-amplitude logic signals.

A switch Wc[m] among the switches Wc[1] to Wc[M] has a first end electrically coupled to the wiring Lc, and a second end electrically coupled to the upper electrode Zu[m] of the piezoelectric element PZ[m] included in the ejection section D[m]. A coupling state specifying signal Qc[m] among the coupling state specifying signals Qc[1] to Qc[M] is input to the control terminal of the switch Wc[m]. A conduction state between the first end and the second end of the switch Wc[m] is switched in accordance with the logic level of the coupling state specifying signal Qc[m] input to the control terminal of the switch Wc[m]. Therefore, the switch Wc[m] switches, in accordance with the coupling state specifying signal Qc[m], whether to supply the drive signal COM propagated through the wiring Lc to the upper electrode Zu[m] of the ejection section D[m] as a supply drive signal VIN[m].

A switch Ws[m] among the switches Ws[1] to Ws[M] has a first end electrically coupled to the wiring Ls, and a second end electrically coupled to the upper electrode Zu[m] of the piezoelectric element PZ[m] included in the ejection section D[m]. A coupling state specifying signal Qs[m] among the coupling state specifying signals Qs[1] to Qs[M] is input to the control terminal of the switch Ws[m]. A conduction state between the first end and the second end of the switch Ws[m] is switched in accordance with the logic level of the coupling state specifying signal Qs[m] input to the control terminal of the switch Ws[m]. Therefore, the switch Ws[m] switches, in accordance with the coupling state specifying signal Qs[m], whether to supply, to the wiring Ls, a signal generated in the upper electrode Zu[m] of the piezoelectric element PZ[m] according to a residual vibration generated in the ejection section D[m].

The switch Wf has a first end electrically coupled to the wiring Lc, and a second end electrically coupled to a first end of the resistor Rf. A second end of the resistor Rf is electrically coupled to the wiring Ls. That is, the first end of the switch Wf is electrically coupled to the wiring Lc, and the second end of the switch Wf is electrically coupled to the wiring Ls via the resistor Rf. The coupling state specifying signal Qf is input to the control terminal of the switch Wf. A conduction state between the first end and the second end of the switch Wf is switched in accordance with a logic level of the coupling state specifying signal Qf input to the control terminal of the switch Wf.

Each of the switches Wc[1] to Wc[M], Ws[1] to Ws[M], and Wf may include, for example, a transmission gate.

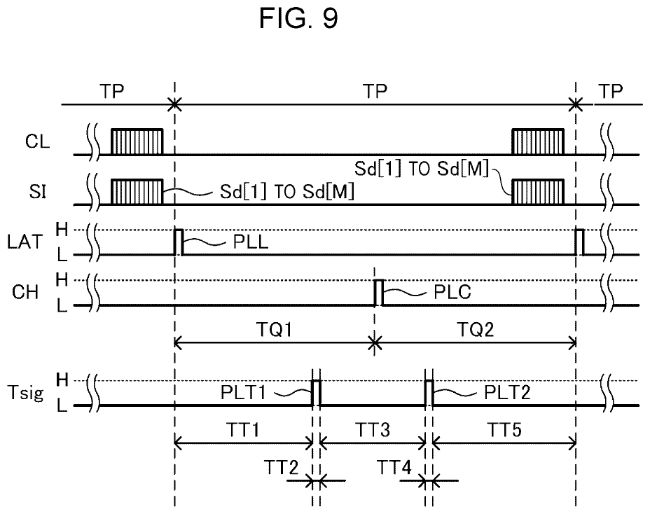

An example of the various signals input to the coupling state specifying circuit 310 will be described. FIG. 9 is a diagram for explaining the example of the various signals input to the coupling state specifying circuit 310. As illustrated in FIG. 9, the liquid ejecting apparatus 1 according to the present embodiment defines one or a plurality of unit periods TP as one or a plurality of operation periods, and controls driving of the ejection section D[m] and the operation of the detection circuit 33 in each of the one or plurality of defined unit periods TP.

Specifically, the control unit 2 generates a latch signal LAT including a pulse PLL and outputs the latch signal LAT to the coupling state specifying circuit 310. For example, the control unit 2 may generate the latch signal LAT including the pulse PLL by setting the logic level of the latch signal LAT to an H level only for a short time at a timing based on at least one of the transport position of the medium P transported along the sub-scanning direction and the scanning position of the carriage 91 reciprocating along the main scanning direction, and may output the latch signal LAT to the coupling state specifying circuit 310. For example, the control unit 2 may generate the latch signal LAT including the pulse PLL by setting the logic level of the latch signal LAT to an H level only for a short time at a predetermined time interval, and may output the latch signal LAT to the coupling state specifying circuit 310. A period from a rising edge of the pulse PLL included in the latch signal LAT to the next rising edge of the pulse PLL corresponds to the unit period TP described above.

Further, the control unit 2 generates a change signal CH including a pulse PLC, and outputs the change signal CH to the coupling state specifying circuit 310. For example, the control unit 2 generates the change signal CH including the pulse PLC by setting the logic level of the change signal CH to an H level only for a short time at a timing when a predetermined time elapses from the rising edge of the pulse PLL, and outputs the change signal CH to the coupling state specifying circuit 310. The pulse PLC included in the change signal CH divides the unit period TP into a control period TQ1 and a control period TQ2. Specifically, the change signal CH divides the unit period TP into the control period TQ1 which is a period of time from the rising edge of the pulse PLL to a rising edge of the pulse PLC, and the control period TQ2 which is a period of time from the rising edge of the pulse PLC to the next rising edge of the pulse PLL. The number of divisions into which the unit period TP is divided by the change signal CH is not limited to two.

The control unit 2 generates a period specifying signal Tsig including pulses PLT1 and PLT2, and outputs the period specifying signal Tsig to the coupling state specifying circuit 310. For example, the control unit 2 sets the logic level of the period specifying signal Tsig to an H level when a predetermined time elapses from the rising edge of the pulse PLL, then sets the logic level of the period specifying signal Tsig to an L level to generate the pulse PLT1, and outputs the pulse PLT1 to the coupling state specifying circuit 310. Thereafter, the control unit 2 sets the logic level of the period specifying signal Tsig to an H level when a predetermined time elapses after the generation of the pulse PLT1, then sets the logic level of the period specifying signal Tsig to an L level to generate the pulse PLT2, and outputs the pulse PLT2 to the coupling state specifying circuit 310. The pulses PLT1 and PLT2 included in the period specifying signal Tsig divide the unit period TP into control periods TT1 to TT5. Specifically, the period specifying signal Tsig divides the unit period TP into the control period TT1 from the rising edge of the pulse PLL to a rising edge of the pulse PLT1, the control period TT2 from the rising edge of the pulse PLT1 to a falling edge of the pulse PLT1, the control period TT3 from the falling edge of the pulse PLT1 to a rising edge of the pulse PLT2, the control period TT4 from the rising edge of the pulse PLT2 to a falling edge of the pulse PLT2, and the control period TT5 from the falling edge of the pulse PLT2 to the next rising edge of the pulse PLL. The number of divisions into which the unit period TP is divided by the period specifying signal Tsig is not limited to five.

Further, the control unit 2 generates a print data signal SI serially including individual specifying signals Sd[1] to Sd[M], and outputs the print data signal SI to the coupling state specifying circuit 310. Each of the individual specifying signals Sd[1] to Sd[M] is a signal including 2-bit information and defines a drive mode of a corresponding one of the ejection sections D[1] to D[M]. In the following description, the 2-bit information included in the individual specifying signal Sd[m] may be referred to as bits S1 and S2 and may be expressed as an individual specifying signal Sd[m]=[S1, S2]. Further, in the following description, in a case where each of the bits S1 and S2 included in the individual specifying signal Sd[m] may be either “1” or “0”, the bits S1 and S2 may be expressed using “*”.

Specifically, before the unit period TP to be controlled, the control unit 2 generates the print data signal SI including the individual specifying signals Sd[1] to Sd[M] that define the drive modes of the ejection sections D[1] to D[M] and the operation of the detection circuit 33 in the unit period TP to be controlled, and outputs the print data signal SI to the coupling state specifying circuit 310. The print data signal SI is held in the register (not illustrated) in the coupling state specifying circuit 310 in a state where the individual specifying signals Sd[1] to Sd[M] are associated with the ejection sections D[1] to D[M], respectively. Then, when the unit period TP to be controlled arrives, the coupling state specifying circuit 310 simultaneously latches the 2-bit information included in each of the held individual specifying signals Sd[1] to Sd[M] and decodes the latched 2-bit information. Thus, the coupling state specifying circuit 310 generates coupling state specifying signals Qc[1] to Qc[M], Qs[m] to Qs[M], Qf, Q1, and Q2 having a logic level corresponding to the content of the decoding in each of the control periods TQ1 and TQ2 in the unit period TP to be controlled or in each of the control periods TT1 to TT5 in the unit period TP to be controlled, and outputs the generated signals Qc[1] to Qc[M], Qs[m] to Qs[M], Qf, Q1, and Q2 to the control terminals of the corresponding switches Wc[1] to Wc[M], Ws[1] to Ws[M], Wf and control terminals of corresponding switches W1 and W2.

Accordingly, a conduction state of each of the switches Wc[1] to Wc[M], Ws[1] to Ws[M], Wf, W1, and W2 in each of the control periods TQ1 and TQ2 or each of the control periods TT1 to TT5 is controlled. As a result, the drive mode of each of the ejection sections D[1] to D[M] and the operation of the detection circuit 33 in each of the control periods TQ1 and TQ2 or each of the control periods TT1 to TT5 are controlled.

With reference to FIG. 8, the detected electrical potential signal VX propagated through the wiring Ls and the coupling state specifying signals Q1 and Q2 output by the coupling state specifying circuit 310 are input to the detection circuit 33. The detection circuit 33 includes a waveform shaping circuit 330 and an AD conversion circuit 331. The waveform shaping circuit 330 acquires the detected electrical potential signal VX in accordance with the coupling state specifying signals Q1 and Q2. The waveform shaping circuit 330 removes noise from the acquired detected electrical potential signal VX and amplifies the detected electrical potential signal VX to shape a signal waveform of the detected electrical potential signal VX and outputs the signal with the shaped signal waveform as a detection signal aSK. The AD conversion circuit 331 converts the analog detection signal aSK output by the waveform shaping circuit 330 into a digital signal and outputs the digital signal as the detection signal SK. The detection signal SK is output from the detection circuit 33 and the head unit 3. That is, the detection circuit 33 changes the signal corresponding to the residual vibration generated in the ejection section D into a digital signal and outputs the digital signal as the detection signal SK.

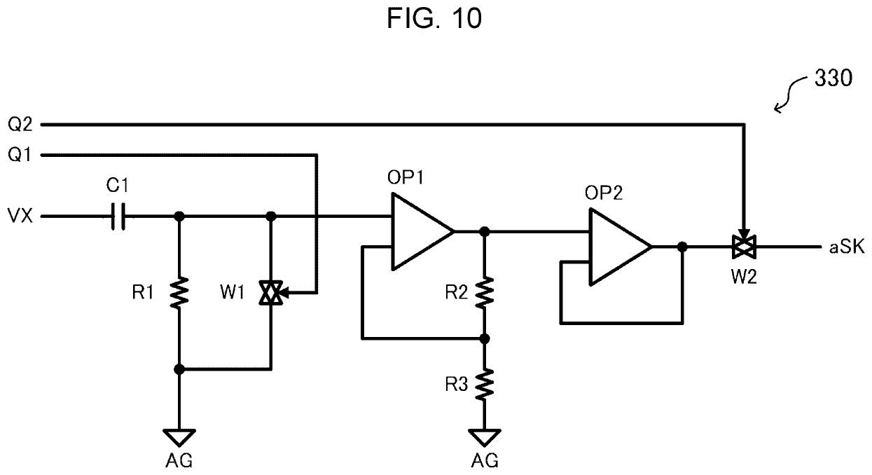

An example of a configuration of the waveform shaping circuit 330 included in the detection circuit 33 will be described. FIG. 10 is a diagram illustrating the example of the configuration of the waveform shaping circuit 330. As illustrated in FIG. 10, the waveform shaping circuit 330 includes a capacitor C1, operational amplifiers OP1 and OP2, the switches W1 and W2, and resistors R1 to R3.

The detected electrical potential signal VX output by the supply switching circuit 31 is input to a first end of the capacitor C1. A second end of the capacitor C1 is electrically coupled to a first end of the resistor R1 and a first end of the switch W1. An analog ground AG fixed at a constant electrical potential is supplied to a second end of the resistor R1 and a second end of the switch W1. That is, the resistor R1 and the switch W1 are coupled in parallel. The coupling state specifying signal Q1 is input to the control terminal of the switch W1. When an H-level coupling state specifying signal Q1 is input to the control terminal of the switch W1, the switch W1 becomes conductive between the first end and the second end of the switch W1. When an L-level coupling state specifying signal Q1 is input to the control terminal of the switch W1, the switch W1 becomes non-conductive between the first end and the second end of the switch W1. That is, the switch W1 switches a conduction state between the first end of the resistor R1 and the analog ground AG. The capacitor C1, the resistor R1, and the switch W1 configured as described above function as a high-pass filter that extracts a signal of a predetermined high frequency component from the detected electrical potential signal VX input in a period of time when the switch W1 is controlled to be non-conductive, and outputs the extracted signal. The switch W1 may include, for example, a transmission gate. The analog ground AG may be, for example, a center electrical potential between a high power supply electrical potential and a low power supply electrical potential that are supplied to the head unit 3.

A positive input terminal of the operational amplifier OP1 is electrically coupled to a coupling point where the second end of the capacitor C1, the first end of the resistor R1, and the first end of the switch W1 are electrically coupled. That is, the signal output by the high-pass filter constituted by the capacitor C1, the resistor R1, and the switch W1 is input to the positive input terminal of the operational amplifier OP1. A negative input terminal of the operational amplifier OP1 is electrically coupled to a coupling point where a first end of the resistor R2 and a first end of the resistor R3 are electrically coupled. An output terminal of the operational amplifier OP1 is electrically coupled to a second end of the resistor R2. The analog ground AG is supplied to a second end of the resistor R3. That is, the operational amplifier OP1 and the resistors R2 and R3 function as a non-inverting amplifier circuit that amplifies the signal input to the positive input terminal of the operational amplifier OP1 in accordance with resistance values of the resistors R2 and R3 and outputs the amplified signal from the output terminal of the operational amplifier OP1. The non-inverting amplifier circuit that includes the operational amplifier OP1 and the resistors R2 and R3 may output a signal obtained by superimposing a predetermined offset voltage on the signal output by the high-pass filter including the capacitor C1, the resistor R1, and the switch W1 and then amplifying a signal obtained by superimposing the predetermined offset voltage on the signal output by the high-pass filter.

A positive input terminal of the operational amplifier OP2 is electrically coupled to the output terminal of the operational amplifier OP1. That is, the signal output by the non-inverting amplifier circuit including the operational amplifier OP1 and the resistors R2 and R3 is input to the positive input terminal of the operational amplifier OP2. A negative input terminal of the operational amplifier OP2 is electrically coupled to an output terminal of the operational amplifier OP2. That is, the operational amplifier OP2 includes a voltage follower circuit. Therefore, the operational amplifier OP2 changes the impedance of the signal output by the non-inverting amplifier circuit including the operational amplifier OP1 and the resistors R2 and R3, and outputs the signal.

A first end of the switch W2 is electrically coupled to the output terminal of the operational amplifier OP2. A signal at a second end of the switch W2 is output as the detection signal aSK from the waveform shaping circuit 330. The coupling state specifying signal Q2 is input to the control terminal of the switch W2. When an H-level coupling state specifying signal Q2 is input to the control terminal of the switch W2, the switch W2 becomes conductive between the first end and the second end of the switch W2. When an L-level coupling state specifying signal Q2 is input to the control terminal of the switch W2, the switch W2 becomes non-conductive between the first end and the second end of the switch W2. The switch W2 switches whether to output the signal output by the operational amplifier OP2 as the detection signal aSK from the waveform shaping circuit 330 in accordance with the logic level of the coupling state specifying signal Q2 input to the control terminal of the switch W2.

As described above, the waveform shaping circuit 330 removes a noise component from the detected electrical potential signal VX by the high-pass filter including the capacitor C1, the resistor R1, and the switch W1, and amplifies the signal, from which the noise component has been removed, by the non-inverting amplifier circuit including the operational amplifier OP1 and the resistors R2 and R3. Then, the waveform shaping circuit 330 performs impedance conversion on the signal by the voltage follower circuit including the operational amplifier OP2 and then outputs the signal as the detection signal aSK. In this case, the switches W1 and W2 switch whether the waveform shaping circuit 330 acquires the detected electrical potential signal VX and outputs the detected electrical potential signal VX as the detection signal aSK.

The detection signal aSK output by the waveform shaping circuit 330 is input to the AD conversion circuit 331. The AD conversion circuit 331 converts the detection signal aSK into a digital signal. The digital signal converted by the AD conversion circuit 331 is output as the detection signal SK from the detection circuit 33 and the head unit 3.

In the head unit 3 according to the present embodiment configured as described above, the supply switching circuit 31 controls the conduction state of the switch Wc[m] in accordance with the print data signal SI propagated based on the clock signal CL in each of the control periods TQ1 and TQ2 or each of the control periods TT1 to TT5 defined by the latch signal LAT, the change signal CH, and the period specifying signal Tsig, thereby switching whether to supply, as the supply drive signal VIN[m], the drive signal COM propagated through the wiring Lc to the piezoelectric element PZ[m] of the ejection section D[m]. Therefore, the drive mode of the ejection section D[m] is controlled.

In the head unit 3 according to the present embodiment, the supply switching circuit 31 controls the conduction state of the switch Ws[m] in accordance with the print data signal SI propagated based on the clock signal CL in each of the control periods TQ1 and TQ2 or each of the control periods TT1 to TT5 defined by the latch signal LAT, the change signal CH, and the period specifying signal Tsig, thereby acquiring a signal corresponding to a residual vibration generated in the ejection section D[m] and switching whether to output the acquired signal as the detected electrical potential signal VX to the detection circuit 33. In this case, the detection circuit 33 amplifies and shapes the signal waveform of the input detected electrical potential signal VX in accordance with the conduction states of the switches W1 and W2 and outputs the signal with the amplified and shaped signal waveform as the detection signal SK. That is, the detection circuit 33 acquires electromotive force generated in the piezoelectric element PZ as the detected electrical potential signal VX due to the deformation of the piezoelectric element PZ according to the residual vibration generated in the ejection section D, amplifies and shapes the signal waveform of the acquired detected electrical potential signal VX, and outputs the signal with the amplified and shaped signal waveform as the detection signal SK.

The detection signal SK output by the detection circuit 33 is input to the determination unit 7. The determination unit 7 determines the state of the target ejection section D[m] based on the input detection signal SK.

As described above, the liquid ejecting apparatus 1 according to the present embodiment includes the detection circuit 33 that detects signals corresponding to the states of the plurality of ejection sections D, and the determination unit 7 that determines the states of the plurality of ejection sections D based on the detection signal SK output by the detection circuit 33. The determination unit 7 determines the state of the ejection section D[1] in accordance with a residual vibration generated in the ejection section D[1] and determines the state of the ejection section D[m] in accordance with a residual vibration generated in the ejection section D[m].

### 5. Operation of Liquid Ejecting Apparatus

An operation of the liquid ejecting apparatus 1 configured as described above will be described. As described above, the liquid ejecting apparatus 1 according to the present embodiment executes the ejection process of ejecting ink onto the medium P so as to form the image based on the image data signal IMG, the determination process of determining the state of the ejection section D that ejects the ink onto the medium P, and the maintenance process of attempting to restore the ejection state of the ejection section D in which an ejection abnormality has occurred in the determination process. Each of operations in the ejection process, the determination process, and the maintenance process executed by the liquid ejecting apparatus 1 will be described.

### 5.1 Ejection Process

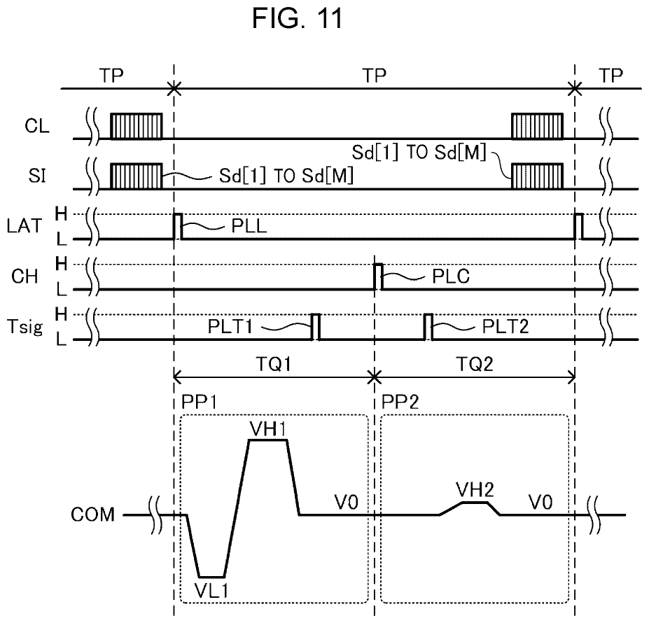

FIG. 11 is a diagram for explaining an example of the various signals output by the control unit 2 in a period of time when the ejection process is executed.

The control unit 2 generates a drive waveform specifying signal dCOM that defines a signal waveform of a drive signal COM to be output by the drive circuit unit 5 in a period of time when the ejection process is executed, and outputs the drive waveform specifying signal dCOM to the drive circuit unit 5. The drive circuit 50 included in the drive circuit unit 5 generates, in accordance with the input drive waveform specifying signal dCOM, the drive signal COM having the signal waveform in which a drive waveform PP1 in a control period TQ1 and a drive waveform PP2 in a control period TQ2 are continuous in each unit period TP as illustrated in FIG. 11. Then, the drive circuit 50 supplies the drive signal COM to the head unit 3.

The drive waveform PP1 is a signal waveform having a voltage value that starts at a reference electrical potential V0, changes to an electrical potential VL1 lower than the reference electrical potential V0, changes to an electrical potential VH1 higher than the reference electrical potential V0, and then ends at the reference electrical potential V0. When the drive waveform PP1 is supplied to the piezoelectric element PZ[m], the piezoelectric element PZ[m] is driven such that a predetermined amount of ink is ejected from the nozzle N[m]. That is, the drive waveform PP1 is a signal waveform for ejecting ink from the nozzle N[m].

The drive waveform PP2 is a signal waveform having a voltage value that starts at the reference electrical potential V0, changes to an electrical potential VH2 higher than the reference electrical potential V0 and lower than the electrical potential VH1, and then ends at the reference electrical potential V0. When the drive waveform PP2 is supplied to the piezoelectric element PZ[m], ink in the vicinity of the opening of the nozzle N[m] vibrates to such an extent that ink is not ejected from the nozzle N[m]. Accordingly, the possibility that the viscosity of the ink stored in the ejection section D[m] including the nozzle N[m] may increase is reduced. In the following description, the operation of vibrating the ink in the vicinity of the opening of the nozzle N[m] by supplying the drive waveform PP2 to the piezoelectric element PZ[m] is referred to as micro-vibration. That is, the drive waveform PP2 is a signal waveform for executing the micro-vibration.

The liquid ejecting apparatus 1 according to the present embodiment selects whether the drive waveform PP1 is supplied to the ejection section D[m] or the drive waveform PP2 is supplied to the ejection section D[m] in each unit period TP in the period of time when the ejection process is executed, and thus controls whether the ink is ejected from the ejection section D[m] or the micro-vibration is executed and whether a dot is formed on the medium P in each unit period TP in the period of time when the ejection process is executed.

Specifically, in the period of time when the liquid ejecting apparatus 1 according to the present embodiment executes the ejection process, the coupling state specifying circuit 310 defines the conduction state of the switch Wc[m] in each of the control periods TQ1 and TQ2 in accordance with the individual specifying signal Sd[m] included in the input print data signal SI. Therefore, in each unit period TP in the period of time when the liquid ejecting apparatus 1 executes the ejection process, it is controlled whether the drive waveform PP1 in the control period TQ1 is supplied to the ejection section D[m] as the supply drive signal VIN[m] or the drive waveform PP2 in the control period TQ2 is supplied to the ejection section D[m] as the supply drive signal VIN[m]. That is, it is controlled whether the ink is ejected from the ejection section D[m] or the micro-vibration of the ejection section D[m] is executed in each unit period TP.

An example of the content of the decoding of the individual specifying signals Sd[1] to Sd[M] by the coupling state specifying circuit 310 will be described, which indicates a relationship between the individual specifying signals Sd[1] to Sd[M] included in the print data signal SI input to the coupling state specifying circuit 310 and the coupling state specifying signals Qc[1] to Qc[M] and Qs[1] to Qs[M] output by the coupling state specifying circuit 310 in the period of time when the liquid ejecting apparatus 1 executes the ejection process.

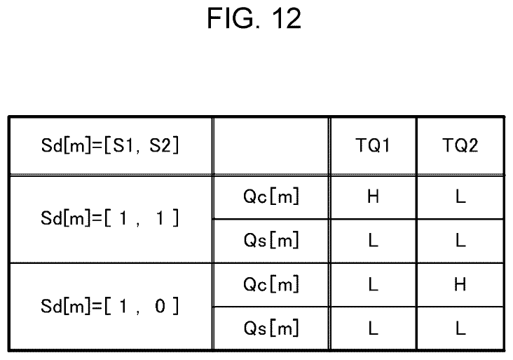

FIG. 12 is a diagram illustrating an example of a relationship between the individual specifying signal Sd[m] and the coupling state specifying signals Qc[m] and Qs[m] in the period of time when the ejection process is executed.

As illustrated in FIG. 12, when an individual specifying signal Sd[m]=[1, 1] is input to the coupling state specifying circuit 310, the coupling state specifying circuit 310 generates a coupling state specifying signal Qc[m] that is at an H level in the control period TQ1 and is at an L level in the control period TQ2, and outputs the generated coupling state specifying signal Qc[m] to the control terminal of the switch Wc[m]. Accordingly, the switch Wc[m] is controlled to be conductive in the control period TQ1 and controlled to be non-conductive in the control period TQ2. Therefore, in the control period TQ1, the supply drive signal VIN[m] including the drive waveform PP1 is supplied to the piezoelectric element PZ[m]. In the control period TQ2, the supply drive signal VIN[m] including the drive waveform PP2 is not supplied to the piezoelectric element PZ[m]. In the control period TQ2 in which the supply drive signal VIN[m] including the drive waveform PP2 is not supplied to the piezoelectric elements PZ[m], the reference electrical potential V0 that is the voltage value of the signal supplied to the upper electrodes Zu[m] immediately before the control period TQ2 is held in the upper electrodes Zu[m] by a capacitance component of the piezoelectric element PZ[m]. That is, in the control period TQ2 in which the supply drive signal VIN[m] including the drive waveform PP2 is not supplied to the piezoelectric elements PZ[m], a constant signal at the reference electrical potential V0 is supplied to the upper electrodes Zu[m]. As a result, the ink is ejected from the nozzle N[m] in the control period TQ1 and is not ejected in the control period TQ2. The ink ejected in the control period TQ1 lands on the medium P, thereby forming a dot on the medium P in the unit period TP.

When an individual specifying signal Sd[m]=[1, 0] is input to the coupling state specifying circuit 310, the coupling state specifying circuit 310 generates a coupling state specifying signal Qc[m] that is at an L level in the control period TQ1 and is at an H level in the control period TQ2, and outputs the generated coupling state specifying signal Qc[m] to the control terminal of the switch Wc[m]. Accordingly, the switch Wc[m] is controlled to be non-conductive in the control period TQ1 and is controlled to be conductive in the control period TQ2. Therefore, the supply drive signal VIN[m] including the drive waveform PP1 is not supplied to the piezoelectric element PZ[m] in the control period TQ1, but the supply drive signal VIN[m] including the drive waveform PP2 is supplied to the piezoelectric element PZ[m] in the control period TQ2. In the control period TQ1 in which the supply drive signal VIN[m] including the drive waveform PP1 is not supplied to the piezoelectric elements PZ[m], the reference electrical potential V0 that is the voltage value of the signal supplied to the upper electrodes Zu[m] immediately before the control period TQ1 is held in the upper electrodes Zu[m] by the capacitance component of the piezoelectric element PZ[m]. That is, in the control period TQ1 in which the supply drive signal VIN[m] including the drive waveform PP1 is not supplied to the piezoelectric element PZ[m], a constant signal at the reference electrical potential V0 is supplied to the upper electrode Zu[m]. As a result, the ink is not ejected from the nozzle N[m] in the control periods TQ1 and TQ2 and the micro-vibration is executed in the control period TQ2. Therefore, a dot is not formed on the medium P in the unit period TP.

As described above, in the ejection process executed by the liquid ejecting apparatus 1, the coupling state specifying circuit 310 outputs the coupling state specifying signals Qs[1] to Qs[M] having the logic levels based on the individual specifying signals Sd[1] to Sd[M] in each of the control periods TQ1 and TQ2 in the unit period TP. Accordingly, the conduction state of each of the switches Wc[1] to Wc[m] in the control periods TQ1 and TQ2 in the unit period TP is controlled, and whether ink is ejected from each of the ejection sections D[1] to D[M] is controlled in each of the control periods TQ1 and TQ2 in the unit period TP. Therefore, the liquid ejecting apparatus 1 can form the image based on the image data signal IMG on the medium P in the period of time when the ejection process is executed.

As illustrated in FIG. 11, in the period of time when the liquid ejecting apparatus 1 executes the ejection process, the coupling state specifying circuit 310 continues outputting an L-level coupling state specifying signal Qs[m] regardless of the input individual specifying signal Sd[m]. Therefore, the switch Ws[m] is controlled to be non-conductive in the period of time when the ejection process is executed. As a result, in the period of time when the liquid ejecting apparatus 1 executes the ejection process, the upper electrode Zu[m] and the wiring Ls are not electrically coupled to each other, and thus the signal corresponding to the residual vibration generated in the ejection section D[m] is not supplied to the detection circuit 33. Therefore, the detection circuit 33 does not acquire the detected electrical potential signal VX in the period of time when the liquid ejecting apparatus 1 executes the ejection process. As a result, although not illustrated, the coupling state specifying circuit 310 continues outputting L-level coupling state specifying signals Qf, Q1, and Q2 in the period of time when the liquid ejecting apparatus 1 executes the ejection process.

### 5.2 Determination Process

Next, the determination process of determining the state of the ejection section D that ejects ink onto the medium P will be described. It is known that a residual vibration is generated in an ejection section that ejects liquid such as ink by driving a drive element such as a piezoelectric element after the drive element is driven. The residual vibration generated in the ejection section is so-called attenuation vibration whose amplitude is decreased with the passage of time, and waveform information such as the amplitude, the attenuation rate of the amplitude, the period, and the frequency of the attenuation vibration is changed based on a state of the ejection section. For example, when the viscosity of the liquid stored in the ejection section changes, the amplitude of the residual vibration generated in the ejection section or the attenuation rate of the amplitude changes. For example, when air bubbles are mixed into the inside of the ejection section, the frequency of the residual vibration generated in the ejection section increases.

In the liquid ejecting apparatus 1 according to the present embodiment, in the determination process of determining the state of the ejection section D that ejects ink onto the medium P, the supply switching circuit 31 included in the head unit 3 acquires the signal corresponding to the residual vibration generated in the ejection section D[m] to be inspected and outputs the signal to the detection circuit 33 as the detected electrical potential signal VX, and the detection circuit 33 generates the detection signal SK by shaping the signal waveform of the input detected electrical potential signal VX. The determination unit 7 calculates, based on the input detection signal SK, waveform information such as the amplitude, the period, and the frequency of the detected electrical potential signal VX based on the input detection signal SK, and waveform information such as the amplitude, the period, and the frequency of the residual vibration generated in the ejection section D[m] to be inspected. The determination unit 7 determines, based on the calculated waveform information, the state of the ejection section D[m] to be inspected. Thereafter, the determination unit 7 generates a state determination signal JH indicating a result of the determination and outputs the state determination signal JH to the control unit 2. Therefore, the control unit 2 can acquire the state of the ejection section D[m] to be inspected, and correct the various signals to be output or notify a user of the state of the ejection section D[m] to be inspected, in accordance with the acquired state of the ejection section D[m] to be inspected.

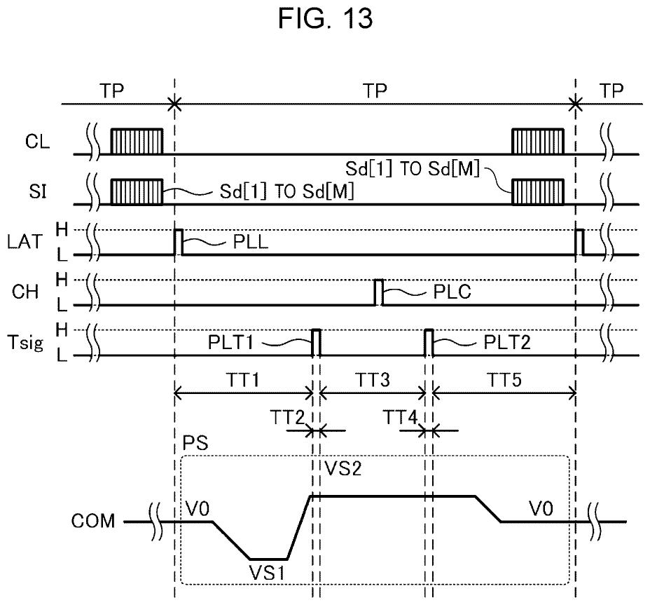

FIG. 13 is a diagram for explaining an example of the various signals that are input to the supply switching circuit 31 of the head unit 3 in a period of time when the determination process is executed.

The control unit 2 generates a drive waveform specifying signal dCOM that defines a signal waveform of a drive signal COM to be output by the drive circuit unit 5 in a period of time when the determination process is executed, and outputs the drive waveform specifying signal dCOM to the drive circuit unit 5. The drive circuit 50 included in the drive circuit unit 5 generates the drive signal COM including a drive waveform PS in each unit period TP as illustrated in FIG. 13 in accordance with the input drive waveform specifying signal dCOM, and supplies the generated drive signal COM to the head unit 3.

The drive waveform PS is a signal waveform having a voltage value that starts at the reference electrical potential V0, changes to an electrical potential VS1 lower than the reference electrical potential V0, and changes to an electrical potential VS2 higher than the reference electrical potential V0 in the control period TT1, is maintained at an electrical potential VS2 in the control periods TT2, TT3, and TT4, and ends at the reference electrical potential V0 in the control period TT5. When the drive waveform PS is supplied to the piezoelectric element PZ[m], the piezoelectric element PZ[m] is driven such that ink is not ejected from the nozzle N[m], and a predetermined residual vibration occurs in the ejection section D[m] at a timing when the voltage value of the drive signal COM becomes the electrical potential VS2 after the piezoelectric element PZ[m] is driven. That is, the drive waveform PS is a signal waveform for driving the piezoelectric element PZ[m] such that ink is not ejected from the nozzle N[m] and generating the predetermined residual vibration in the ejection section D[m]. Therefore, when the drive waveform PS is supplied to the piezoelectric element PZ[m], the ejection section D[m] does not eject ink and operates so as to generate the residual vibration.

In each of the control periods TT1 to TT5 in each unit period TP in the period of time when the liquid ejecting apparatus 1 executes the determination process, by controlling the conduction state of each of the switches Wc[1] to Wc[M], Ws[1] to Ws[M], Wf, W1, and W2, the supply switching circuit 31 supplies a supply drive signal VIN[m] including the drive waveform PS to the ejection section D[m] to be inspected, acquires, in response to the supply of the supply drive signal VIN[m] including the drive waveform PS, the signal corresponding to the residual vibration generated in the ejection section D[m] to be inspected, and outputs the acquires signal to the detection circuit 33 as the detected electrical potential signal VX. Then, the detection circuit 33 generates the detection signal SK by shaping the signal waveform of the input detected electrical potential signal VX, and the determination unit 7 determines, based on the detection signal SK, the state of the ejection section D[m] to be inspected.

An example of the content of the decoding of the individual specifying signals Sd[1] to Sd[M] by the coupling state specifying circuit 310 in the period of time when the liquid ejecting apparatus 1 executes the determination process will be described, which indicates a relationship between the individual specifying signals Sd[1] to Sd[M] included in the print data signal SI input to the coupling state specifying circuit 310 and the coupling state specifying signals Qc[1] to Qc[M], Qs[1] to Qs[M] and Qf, Q1, and Q2 output by the coupling state specifying circuit 310 in the period of time when the liquid ejecting apparatus 1 executes the determination process.

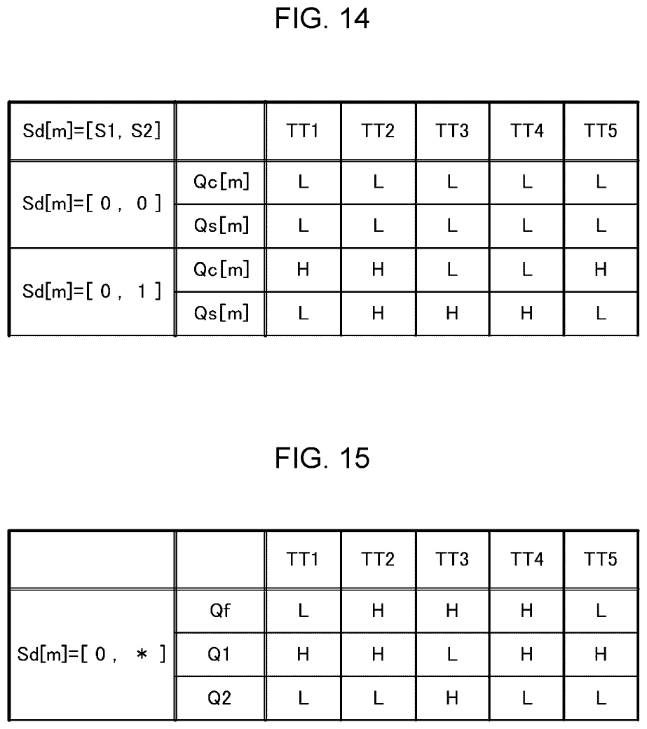

FIG. 14 is a diagram illustrating an example of a relationship between the individual specifying signal Sd[m] and the coupling state specifying signals Qc[m] and Qs[m] in the period of time when the determination process is executed. Description will be made assuming that, in the period of time when the determination process is executed in the liquid ejecting apparatus 1 according to the present embodiment, the control unit 2 outputs an individual specifying signal Sd[m]=[0, 0] to the coupling state specifying circuit 310 in a case where the ejection section D[m] is not to be inspected, and outputs an individual specifying signal Sd[m]=[0, 1] to the coupling state specifying circuit 310 in a case where the ejection section D[m] is to be inspected.

As illustrated in FIG. 14, when the individual specifying signal Sd[m]=[0, 0] is input to the coupling state specifying circuit 310, the coupling state specifying circuit 310 generates a coupling state specifying signal Qc[m] that is at an L level in the control periods TT1 to TT5, outputs the generated coupling state specifying signal Qc[m] to the control terminal of the switch Wc[m], generates a coupling state specifying signal Qs[m] that is at an L level in the control periods TT1 to TT5, and outputs the generated coupling state specifying signal Qs[m] to the control terminal of the switch Ws[m]. Thus, in the control periods TT1 to TT5, the switch Wc[m] is controlled to be non-conductive and the switch Ws[m] is controlled to be non-conductive. In this case, the supply drive signal VIN[m] corresponding to the drive signal COM is not supplied to the piezoelectric element PZ[m] of the ejection section D[m] that is not to be inspected. Therefore, a residual vibration is not generated in the ejection section D[m] that is not to be inspected, and in this case, even if the electrical potential of the upper electrode Zu[m] of the piezoelectric element PZ[m] included in the ejection section D[m] that is not to be inspected is changed, a signal corresponding to the change in the electrical potential is not supplied to the wiring Ls. Therefore, the determination of the state of the ejection section D[m] that is not to be inspected is not executed.

When the individual specifying signal Sd[m]=[0, 1] is input to the coupling state specifying circuit 310, the coupling state specifying circuit 310 generates a coupling state specifying signal Qc[m] that is at an H level in the control periods TT1, TT2, and TT5 and at an L level in the control periods TT3 and TT4, outputs the generated coupling state specifying signal Qc[m] to the control terminal of the switch Wc[m], generates a coupling state specifying signal Qs[m] that is at an H level in the control periods TT2 to TT4 and at an L level in the control periods TT1 and TT5, and outputs the generated coupling state specifying signal Qs[m] to the control terminal of the switch Ws[m]. Therefore, the switch Wc[m] is controlled to be conductive in the control periods TT1, TT2, and TT5 and is controlled to be non-conductive in the control periods TT3 and TT4, and the switch Ws[m] is controlled to be conductive in the control periods TT2 to TT4 and is controlled to be non-conductive in the control periods TT1 and TT5.

FIG. 15 is a diagram illustrating an example of a relationship between the individual specifying signal Sd[m] and the coupling state specifying signals Qf, Q1, and Q2 in the period of time when the determination process is executed. In the period of time when the determination process is executed, the coupling state specifying circuit 310 outputs the coupling state specifying signals Qf, Q1, and Q2 having the same logic levels in each of the control periods TT1 to TT5 when the individual specifying signal Sd[m]=[0, 0] is input and when the individual specifying signal Sd[m]=[0, 1] is input. Therefore, in FIG. 15, the individual specifying signal Sd[m]=[0, 0] and the individual specifying signal Sd[m]=[0, 1] are collectively illustrated as an individual specifying signal Sd[m]=[0, *].

As illustrated in FIG. 15, when the individual specifying signal Sd[m]=[0, *] is input to the coupling state specifying circuit 310, the coupling state specifying circuit 310 generates a coupling state specifying signal Qf that is at an H level in the control periods TT2 to TT4 and is at an L level in the control periods TT1 and TT5, outputs the generated coupling state specifying signal Qf to the control terminal of the switch Wf, generates a coupling state specifying signal Q1 that is at an H level in the control periods TT1, TT2, TT4, and TT5 and is at an L level in the control period TT3, outputs the generated coupling state specifying signal Q1 to the control terminal of the switch W1, generates a coupling state specifying signal Q2 that is at an H level in the control period TT3 and is at an L level in the control period TT1, TT2, TT4, and TT5, and outputs the generated coupling state specifying signal Q2 to the control terminal of the switch W2. Therefore, the switch Wf is controlled to be conductive in the control periods TT2 to TT4 and controlled to be non-conductive in the control periods TT1 and TT5, the switch W1 is controlled to be conductive in the control periods TT1, TT2, TT4, and TT5 and controlled to be non-conductive in the control period TT3, and the switch W2 is controlled to be conductive in the control period TT3 and controlled to be non-conductive in the control periods TT1, TT2, TT4, and TT5.

An example of an operation of the liquid ejecting apparatus 1 when the individual specifying signal Sd[m]=[0, 1] corresponding to the ejection section D[m] to be inspected is input to the coupling state specifying circuit 310, that is, an example of an acquisition operation in which the detection circuit 33 acquires the detected electrical potential signal VX based on the signal corresponding to the residual vibration generated in the ejection section D[m] to be inspected will be described.

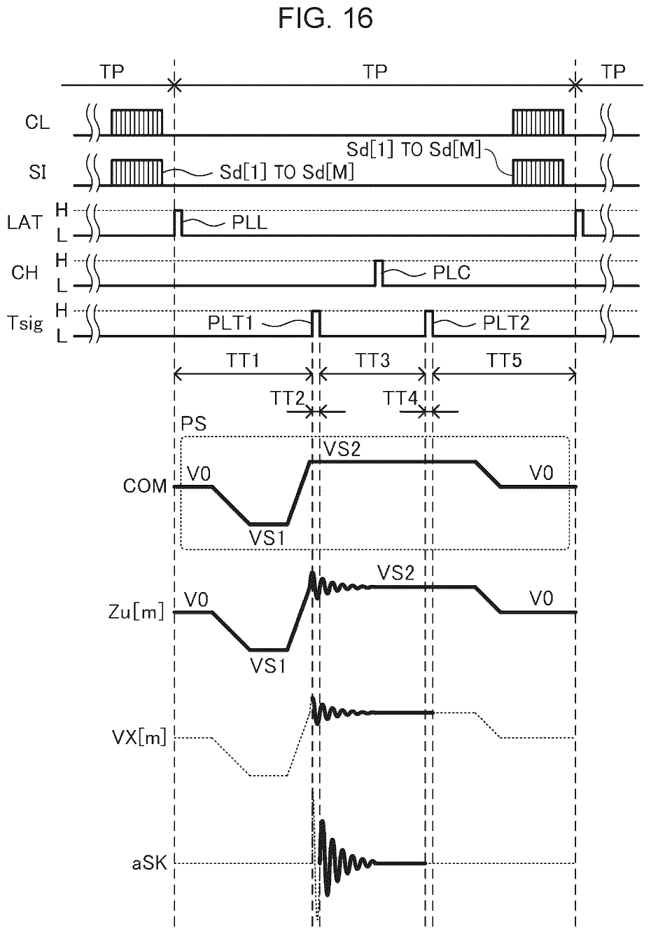

FIG. 16 is a diagram for explaining the example of the operation of acquiring the detected electrical potential signal VX based on the signal corresponding to the residual vibration generated in the ejection section D[m] to be inspected. As illustrated in FIG. 16, the drive signal COM including the drive waveform PS having the voltage value that starts at the reference electrical potential V0 in the control period TT1, changes to the electrical potential VS1 lower than the reference electrical potential V0, then changes to the electrical potential VS2 higher than the reference electrical potential V0, is maintained at the electrical potential VS2 in the control periods TT2 to TT4, and changes to the reference electrical potential V0 and ends in the control period TT5 is supplied to the coupling state specifying circuit 310 in each unit period TP in the period of time when the determination process is executed.

Then, in the period of time when the determination process is executed, the control unit 2 outputs, to the coupling state specifying circuit 310, the individual specifying signal Sd[m]=[0, 1] corresponding to the ejection section D[m] to be inspected. In this case, the ejection sections D[1] to D[m−1] and D[m+1] to D[M] are not to be inspected. That is, the control unit 2 outputs individual specifying signals Sd[1] to Sd[m−1]=[0, 0] and Sd[m+1] to Sd[M]=[0, 0] to the coupling state specifying circuit 310.

When the print data signal SI including the individual specifying signal Sd[m]=[0, 1] and the individual specifying signals Sd[1] to Sd[m−1]=[0, 0] and Sd[m+1] to Sd[M]=[0, 0] is input to the coupling state specifying circuit 310, the switch Wc[m] is controlled to be conductive and the switches Wc[1] to Wc[m−1] and Wc[m+1] to Wc[m] are controlled to be non-conductive in the control periods TT1 and TT2. Therefore, in the control periods TT1 and TT2, the supply drive signal VIN[m] having a voltage value that starts at the reference electrical potential V0, changes to the reference potential VS1 lower than the reference electrical potential V0, then changes to the electrical potential VS2 higher than the reference electrical potential V0, and is maintained at the potential VS2 is supplied to the upper electrode Zu[m], and the upper electrodes Zu[1] to Zu[m−1] and Zu[m+1] to Zu[M] are held at the reference electrical potential V0. In this case, when the voltage value of the supply drive signal VIN[m] supplied becomes constant at the electrical potential VS2, a residual vibration occurs in the ejection section D[m] to be inspected. Then, the piezoelectric body Zm[m] is deformed according to the residual vibration generated in the ejection section D[m] to be inspected, and electromotive force corresponding to the deformation of the piezoelectric body Zm[m] is generated in the upper electrode Zu[m]. That is, in the upper electrode Zu[m] of the piezoelectric element PZ[m] included in the ejection section D[m] to be inspected, a signal corresponding to the residual vibration generated in the ejection section D[m] to be inspected is generated.

In the control period TT2, the switch Ws[m] is controlled to be conductive, the switches Ws[1] to Ws[m−1] and Ws[m+1] to Ws[M] are controlled to be non-conductive, the switch Wf is controlled to be conductive, and therefore the signal corresponding to the residual vibration generated in the ejection section D[m] to be inspected propagates through the wiring Ls as the detected electrical potential signal VX. In this case, the switch W1 is controlled to be conductive and the switch W2 is controlled to be non-conductive. Therefore, in the control period TT2, the waveform shaping circuit 330 included in the detection circuit 33 does not acquire the detected electrical potential signal VX propagating through the wiring Ls, and thus does not output the detection signal aSK corresponding to the detected electrical potential signal VX.

In the control period TT3, the switch W1 is controlled to be non-conductive, the switch W2 is controlled to be conductive, and therefore the waveform shaping circuit 330 included in the detection circuit 33 acquires the detected electrical potential signal VX that is the signal corresponding to the residual vibration generated in the ejection section D[m] to be inspected and has propagated through the wiring Ls, shapes the signal waveform of the acquired detected electrical potential signal VX, and outputs the signal with the shaped signal waveform as the detection signal aSK. The detection signal aSK output by the waveform shaping circuit 330 is converted into a digital signal by the AD conversion circuit 331, and the digital signal is input to the determination unit 7 as the detection signal SK.

The determination unit 7 calculates, based on the input detection signal SK, waveform information such as the amplitude, the period, and the frequency of the detected electrical potential signal VX, that is, waveform information such as the amplitude, the period, and the frequency of the residual vibration generated in the ejection section D[m] to be inspected. Then, the determination unit 7 determines, based on the calculated waveform information, the state of the ejection section D[m] to be inspected, and outputs a state determination signal JH indicating the result of the determination to the control unit 2.

In the subsequent control period TT4, the switch W1 is controlled to be conductive, the switch W2 is controlled to be non-conductive, and therefore the waveform shaping circuit 330 stops acquiring the detected electrical potential signal VX propagating through the wiring Ls and stops outputting the detection signal aSK. Then, in the control period TT5, the switch Wc[m] is controlled to be conductive, the switch Ws[m] is controlled to be non-conductive, and therefore the supply of the signal generated in the upper electrode Zu[m] to the wiring Ls is stopped, and the supply drive signal VIN[m] having the reference electrical potential V0 is supplied to the upper electrode Zu[m] of the piezoelectric element PZ[m] included in the ejection section D[m] to be inspected. Therefore, the electrical potential of the upper electrode Zu[m] of the piezoelectric element PZ[m] included in the ejection section D[m] to be inspected is controlled to the reference electrical potential V0.

### 5.3 Maintenance Process

Next, an example of the maintenance process of attempting to restore the ejection state of the ejection section D in which an ejection abnormality has occurred in the determination process will be described. The maintenance process in the present embodiment includes a pump suction process, a flushing process, and a wiping process. The maintenance process is not limited thereto, and includes various processes for restoring the ejection state of the ejection section D.

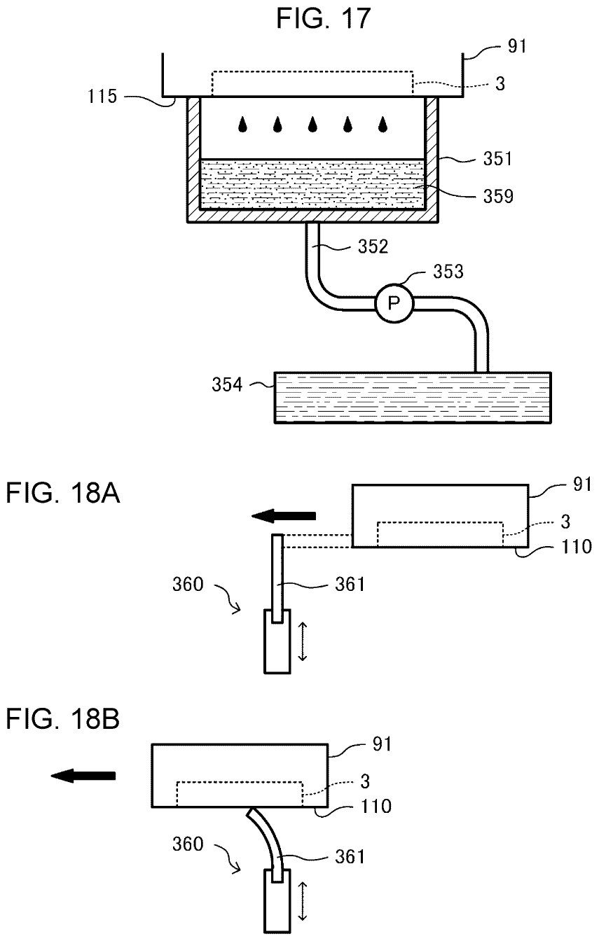

FIG. 17 is a diagram illustrating an example of the pump suction process. As illustrated in FIG. 17, the pump suction process is executed using a cap 351, a tube 352, a pump 353, and a waste liquid tank 354.

The cap 351 is located so as to cover, from the ejection surface 115 side, the plurality of head units 3 mounted on the carriage 91. A first end of the tube 352 is attached to the cap 351. A second end of the tube 352 is coupled to the waste liquid tank 354 via the pump 353.

When the pump 353 operates, air inside the cap 351 is drawn into the pump 353. Accordingly, ink stored in the plurality of ejection sections D included in each of the head units 3 is introduced into the waste liquid tank 354. In this case, ink fixed in the vicinity of the nozzles N of the ejection sections D, air bubbles mixed into the ejection sections D, and the like are removed.

Further, as illustrated in FIG. 17, the cap 351 may have an ink absorber 359 therein. The ink absorber 359 absorbs and temporarily stores ink sucked from the nozzles N in the pump suction process. As a result, it is possible to reduce the possibility that the sucked ink may rebound and adhere to the ejection surface 115 in a period of time when the pump suction process is executed.

FIGS. 18A and 18B are diagrams illustrating an example of the wiping process. As illustrated in FIGS. 18A and 18B, the wiping process is executed by a wiper 360 including a wiping member 361. As illustrated in FIG. 18A, the wiper 360 has a range in which the wiping member 361 can come into contact with the ejection surface 115, and is movable in the vertical direction in FIG. 18A. When the wiping process is executed, the wiper 360 moves such that at least a portion of the wiping member 361 is positioned above the ejection surface 115 in FIG. 18A. Thereafter, by the operation of the carriage moving unit 9, the carriage 91 on which the head unit 3 is mounted moves in a direction along an arrow illustrated in FIG. 18A. Accordingly, as illustrated in FIG. 18B, the wiping member 361 comes into contact with the ejection surface 115.

The wiping member 361 is made of plastic rubber or the like. Therefore, when the wiping member 361 comes into contact with the ejection surface 115, a distal end portion of the wiping member 361 is bent. As a result, the wiping member 361 can wipe the ejection surface 115 so as to remove a paper piece or the like adhering to the ejection surface 115.

In the flushing process, for example, in a state where the cap 351 illustrated in FIG. 17 is mounted, ink is simultaneously ejected from the plurality of nozzles N included in the plurality of ejection sections D included in the target head unit 3. By the flushing process, the ink stored in the plurality of ejection sections D included in the head unit 3 is refreshed. As a result, the viscosity of the ink stored in the plurality of ejection sections D included in the head unit 3 is restored to and maintained in an appropriate range. In addition, in the flushing process, the ink may be simultaneously ejected from the plurality of nozzles N included in the plurality of ejection sections D included in the head unit 3. Therefore, the flushing process may be executed to supply a drive signal COM including a predetermined signal waveform to the plurality of ejection sections D by inputting a predetermined print data signal SI to the head unit 3 in a state where the cap 351 is mounted on the head unit 3, and to simultaneously eject the ink from the plurality of nozzles N included in the plurality of ejection sections D.

The control unit 2 may select any one of the pump suction process, the flushing process, and the wiping process as the maintenance process based on the state determination signal JH output by the determination unit 7, and cause the maintenance unit 10 to execute the selected process. For example, the control unit 2 may cause the maintenance unit 10 to execute the pump suction process if the control unit 2 determines, based on the state determination signal JH, that a cause of an ejection abnormality occurring in an ejection section D is the mixing of air bubbles into the ejection section D, may cause the maintenance unit 10 to execute the flushing process or the pump suction process if the control unit 2 determines, based on the state determination signal JH, that the cause of the ejection abnormality occurring in the ejection section D is the thickening of ink, and may cause the maintenance unit 10 to execute the wiping process if the control unit 2 determines, based on the state determination signal JH, that the cause of the ejection abnormality occurring in the ejection section D is the adhesion of a paper piece to the ejection surface 115. Accordingly, the maintenance unit 10 attempts to restore the state of the ejection section D in which the ejection abnormality has occurred.

In a case where an ejection abnormality occurs in a plurality of ejection sections D included in the head unit 3, the maintenance unit 10 may execute all of the pump suction process, the flushing process, and the wiping process regardless of a cause of the ejection abnormality.

That is, the liquid ejecting apparatus 1 according to the present embodiment includes the maintenance unit 10 that executes the maintenance process on the ejection section D in order to attempt to restore the state of the ejection section D, and the maintenance unit 10 executes the wiping process of wiping the ejection surface 115 onto which ink is ejected from the recording head 32 included in the head unit 3 and the flushing process of ejecting ink from the plurality of ejection sections D in order to restore the viscosity of the stored ink as the maintenance process.

### 6. Operation of Liquid Ejecting Apparatus and Control of Sink Capability

The relationship between the operation of the liquid ejecting apparatus 1 and the control of the sink capability in the sink circuit 40 included in the sink unit 4 will be described.

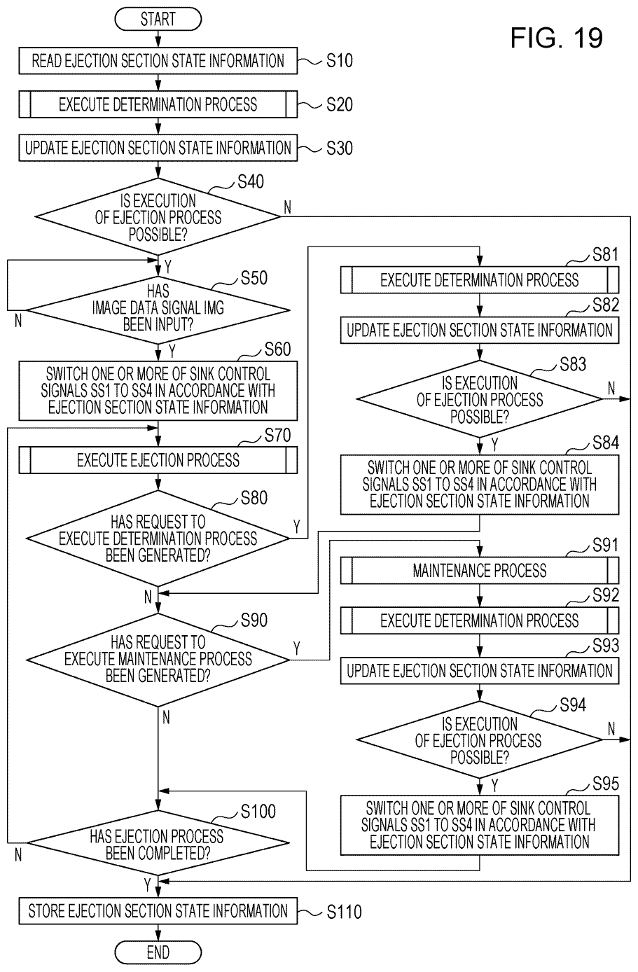

FIG. 19 is a diagram for explaining the control of the sink capability in the sink circuit 40. As illustrated in FIG. 19, when the liquid ejecting apparatus 1 starts operating, the control unit 2 reads ejection section state information from a storage circuit (not illustrated) (step S10) and holds the ejection section state information. The ejection section state information read by and held in the control unit 2 is information regarding the ejection states of the ejection sections D[1] to D[M] and stored in the storage circuit of the control unit 2 according to the state determination signal JH input to the control unit 2 in the determination process, and includes, for example, information indicating whether an ejection abnormality has occurred in each of the ejection sections D[1] to D[M], information indicating the number of ejection sections D in which an ejection abnormality has occurred among the ejection sections D[1] to D[M] of the head unit 3, and the like.

Thereafter, the liquid ejecting apparatus 1 executes the determination process described with reference to FIGS. 13 to 16 (step S20). Specifically, when the determination process is started, the control unit 2 generates a clock signal CL, a print data signal SI, a latch signal LAT, a change signal CH, a period specifying signal Tsig, and a drive waveform specifying signal dCOM for setting the ejection section D[1] as an ejection section D to be inspected, and outputs the generated signals to the corresponding components. Accordingly, a state determination signal JH corresponding to the ejection section D[1] is input to the control unit 2. That is, the control unit 2 acquires information indicating a result of determining whether an ejection abnormality has occurred in the ejection section D[1].

Similarly, the control unit 2 generates a clock signal CL, a print data signal SI, a latch signal LAT, a change signal CH, a period specifying signal Tsig, and a drive waveform specifying signal dCOM for sequentially specifying each of the ejection sections D[2] to D[M] as an ejection section D to be inspected, and outputs the generated signals to the corresponding components. Accordingly, state determination signals JH corresponding to the respective ejection sections D[2] to D[M] are sequentially input to the control unit 2. That is, the control unit 2 sequentially acquires information indicating results of determining whether an ejection abnormality has occurred in each of the ejection sections D[2] to D[M].

In the following description, the control unit 2 acquires all of results of determining whether an ejection abnormality has occurred in each of the ejection sections D[1] to D[M] in a single determination process, but the control unit 2 may be configured to acquire results of determining whether an ejection abnormality has occurred in each of the ejection sections D[1] to D[M] in a plurality of determination processes into which the determination process is divided. For example, the control unit 2 may acquire results of determining whether an ejection abnormality has occurred in each of the ejection sections D[1] to D[m] among the ejection sections D[1] to D[M] in the first determination process, and may acquire results of determining whether an ejection abnormality has occurred in each of the ejection sections D[m+1] to D[M] among the ejection sections D[1] to D[M] in the second determination process.

Then, after the determination process in step S20 is completed, the control unit 2 updates the held ejection section state information based on the acquired results of determining whether an ejection abnormality has occurred in each of the ejection sections D[1] to D[M](step S30). That is, the control unit 2 updates, based on the determination results of the determination process in step S20, the held information indicating whether an ejection abnormality has occurred in each of the ejection sections D[1] to D[M] and the held information indicating the number of ejection sections D in which an ejection abnormality has occurred among the ejection sections D[1] to D[M] included in the head unit 3.

Then, the control unit 2 determines, based on the updated held ejection section state information, whether the execution of the ejection process is possible (step S40). Specifically, the control unit 2 determines whether an ejection section D in which an ejection abnormality has occurred among the ejection sections D[1] to D[M] included in the head unit 3 is able to be complemented by a complementing process, based on the information included in the held ejection section state information and indicating whether an ejection abnormality has occurred in each of the ejection sections D[1] to D[M]. Then, the control unit 2 may determine that the execution of the ejection process is possible if the ejection section D is able to be complemented by the complementing process, and may determine that the execution of the ejection process is not possible if the ejection section D is not able to be complemented by the complementing process. In addition, the control unit 2 determines whether the number of ejection sections D that is indicated in the held ejection section state information and in which an ejection abnormality has occurred among the ejection sections D[1] to D[M] exceeds a predetermined number. Then, the control unit 2 may determine that the execution of the ejection process is possible if the number of ejection sections D in which an ejection abnormality has occurred is equal to or less than the predetermined number, and may determine that the execution of the ejection process is not possible if the number of ejection sections D in which an ejection abnormality has occurred exceeds the predetermined number. If the control unit 2 determines that the execution of the ejection process is not possible (N in step S40), the control unit 2 ends the process, and the liquid ejecting apparatus 1 stops operating. In this case, the control unit 2 may notify, via a notification mechanism (not illustrated), the user that the execution of the ejection process is not possible.

If the control unit 2 determines that the execution of the ejection process is possible (Y in step S40), the control unit 2 determines whether the image data signal IMG has been input to the control unit 2 (step S50). If the image data signal IMG has not been input to the control unit 2 (N in step S50), the control unit 2 waits until the image data signal IMG is input to the control unit 2.

Thereafter, when the image data signal IMG is input to the control unit 2 (Y in step S50), the control unit 2 outputs the sink control signals SS1 to SS4 for controlling the sink capability of the sink circuit 40, in accordance with the information included in the held ejection section state information and indicating the number of ejection sections D in which an ejection abnormality has occurred. That is, the control unit 2 switches one or more of the sink control signals SS1 to SS4 in accordance with the held ejection section state information (step S60).

Specifically, in a case where an ejection abnormality has not occurred in all of the ejection sections D, the control unit 2 outputs the H-level sink control signals SS1 to SS4. In a case where the number of ejection sections D in which an ejection abnormality has occurred is a, the control unit 2 outputs the L-level sink control signal SS1 and the H-level sink control signals SS2 to SS4. In a case where the number of ejection sections D in which an ejection abnormality has occurred is b that is greater than a, the control unit 2 outputs the L-level sink control signals SS1 and SS2 and the H-level sink control signals SS3 and SS4. In a case where the number of ejection sections D in which an ejection abnormality has occurred is c that is greater than b, the control unit 2 outputs the L-level sink control signals SS1 to SS3 and the H-level sink control signal SS4. In a case where the number of ejection sections D in which an ejection abnormality has occurred is d that is greater than c, the control unit 2 outputs the L-level sink control signals SS1 to SS4. That is, the control unit 2 outputs the sink control signals SS1 to SS4 so as to decrease the resistance value of the variable resistance circuit 410 included in the sink circuit 40 when the number of ejection sections D in which an ejection abnormality has occurred increases. Therefore, the control unit 2 controls the sink circuit 40 so as to increase the sink capability when the number of ejection sections D in which an ejection abnormality has occurred increases. In this case, a is any integer satisfying “1 a”, b is any integer satisfying “a<b”, c is any integer satisfying “b<c”, and d is any integer satisfying “c<d”.

In other words, the sink circuit 40 has an operation mode in which the impedance value between the wiring Lb and the wiring Lg is set to the resistance value in the state where the transistor 403 is non-conductive, an operation mode in which the impedance value between the wiring Lb and the wiring Lg is set to the resistance value that is less than the resistance value in the state where the transistor 403 is non-conductive, and is equal to the resistance value of the resistor 411, an operation mode in which the impedance value between the wiring Lb and the wiring Lg is set to the resistance value that is less than the resistance value of the resistor 411 and equal to the combined resistance value of the resistors 411 and 412 coupled in parallel, an operation mode in which the impedance value between the wiring Lb and the wiring Lg is set to the resistance value that is less than the combined resistance value of the resistors 411 and 412 coupled in parallel and is equal to the combined resistance value of the resistors 411 to 413 coupled in parallel, an operation mode in which the impedance value between the wiring Lb and the wiring Lg is set to the resistance value that is less than the combined resistance value of the resistors 411 to 413 coupled in parallel and is equal to the combined resistance value of the resistors 411 to 414 coupled in parallel, and an operation mode in which the impedance value between the wiring Lb and the wiring Lg is set to the resistance value that is less than the combined resistance value of the resistors 411 to 414 coupled in parallel and is equal to the combined resistance value of the resistors 411 to 415 coupled in parallel. The operation modes are switched in accordance with the number of ejection sections D determined to be abnormal by the determination unit 7 among the plurality of ejection sections D.

Thereafter, the liquid ejecting apparatus 1 executes the ejection process described with reference to FIGS. 11 and 12 (step S70). Specifically, when the ejection process is started, the control unit 2 generates the individual specifying signals Sd[1] to Sd[M] corresponding to the input image data signal IMG. Then, the control unit 2 generates a print data signal SI by executing the complementing process on the generated individual specifying signals Sd[1] to Sd[M] based on the information included in the held ejection section state information and indicating whether an ejection abnormality has occurred in each of the ejection sections D[1] to D[M]. Thereafter, the control unit 2 outputs the generated print data signal SI, the clock signal CL, the latch signal LAT, the change signal CH, the period specifying signal Tsig, and the drive waveform specifying signal dCOM to the corresponding components. Accordingly, the head unit 3 ejects ink in accordance with the print data signal SI, the clock signal CL, the latch signal LAT, the change signal CH, the period specifying signal Tsig, and the drive waveform specifying signal dCOM. As a result, a dot is formed at a predetermined position on the medium P.

In this case, the control unit 2 executes the above-described complementing process such that the ejection section D[m] determined to be abnormal by the determination unit 7 among the plurality of ejection sections D does not eject ink in the unit period TP in which the ejection process is executed and in which ink is ejected from the head unit 3, and that at least one of the ejection section D[m+1] and the ejection section D[m−1] that are located adjacent to the ejection section D[m] among the plurality of ejection sections D and determined not to be abnormal by the determination unit 7 ejects ink to complement the ejection section D[m] in the unit period TP in which the ejection process is executed and in which ink is ejected from the head unit 3.

Further, the control unit 2 determines whether a request to execute the determination process has been generated (step S80). The request to execute the determination process is generated, for example, when the operation direction of the carriage 91 on which the head unit 3 is mounted is switched or when the carriage 91 is positioned between media P transported.

If the control unit 2 determines that the request to execute the determination process has been generated (Y in step S80), the liquid ejecting apparatus 1 executes a determination process similar to step S20 (step S81), and the control unit 2 updates the held ejection section state information in accordance with a determination result obtained in the determination process in step S30 in a similar manner to step S81 (step S82). Then, similarly to step S40, the control unit 2 determines whether the execution of the ejection process is possible, based on the held ejection section state information updated in step S82 (step S83). If the control unit 2 determines that the execution of the ejection process is not possible (N in step S83), the control unit 2 ends the process and the liquid ejecting apparatus 1 stops operating. If the control unit 2 determines that the execution of the ejection process is possible (Y in step S83), the control unit 2 switches one or more of the sink control signals SS1 to SS4 in accordance with the held ejection section state information in a similar manner to step S60 (step S84). Therefore, the sink capability of the sink circuit 40 is updated in accordance with the latest states of the ejection sections D[1] to D[M].

If the control unit 2 determines that the request to execute the determination process has not been generated (N in step S80), or after the control unit 2 switches one or more of the sink control signals SS1 to SS4 in accordance with the held ejection section state information in step S84, the control unit 2 determines whether a request to execute the maintenance process has been generated (step S90). The request to execute the maintenance process may be generated, for example, when the operation direction of the carriage 91 on which the head unit 3 is mounted is switched after it is determined that a new ejection abnormality has occurred in at least one of the ejection sections D[1] to D[M] in the determination process, or when the carriage 91 is positioned between media P transported, or when the operation direction of the carriage 91 on which the head unit 3 is mounted is switched after the cumulative operating time or the continuous operating time of the liquid ejecting apparatus 1 or the number of surfaces of a medium P onto which ink has been ejected reaches a predetermined threshold, or when the formation of the image corresponding to the image data signal IMG has been completed.

If the control unit 2 determines that the request to execute the maintenance process has been generated (Y in step S90), the control unit 2 causes the maintenance unit 10 to execute the maintenance process such as the pump suction process, the flushing process, and the wiping process described above (step S91). Then, after the maintenance process in the maintenance unit 10 is completed, the liquid ejecting apparatus 1 executes a determination process similar to step S20 (step S92), and the control unit 2 updates the held ejection section state information in accordance with a determination result obtained in the determination process in step S30 in a similar manner to step S92 (step S93). Then, similarly to step S40, the control unit 2 determines, based on the ejection section state information updated in step S93, whether the execution of the ejection process is possible (step S94). Then, if the control unit 2 determines that the execution of the ejection process is not possible (N in step S94), the control unit 2 ends the process and the liquid ejecting apparatus 1 stops operating. If the control unit 2 determines that the execution of the ejection process is possible (Y in step S94), the control unit 2 switches one or more of the sink control signals SS1 to SS4 in accordance with the held ejection section state information in a similar manner to step S60 (step S95). Therefore, the sink capability of the sink circuit 40 is updated in accordance with the latest states of the ejection sections D[1] to D[M]. That is, in a case where a state of an ejection section D in which an ejection abnormality has occurred is restored by the maintenance process, the control unit 2 controls the sink circuit 40 so as to lower the sink capability.

If the control unit 2 determines that the request to execute the maintenance process has not been generated (N in step S90), or after the control unit 2 switches one or more of the sink control signals SS1 to SS4 in accordance with the held ejection section state information in step S95, the control unit 2 determines whether the formation of the image corresponding to the image data signal IMG onto the medium P, that is, the ejection process corresponding to the image data signal IMG has been completed (step S100). If the control unit 2 determines that the ejection process corresponding to the image data signal IMG has not been completed (N in step S100), the processing in steps S70 to S90 described above is executed again.

On the other hand, if the control unit 2 determines that the ejection process corresponding to the image data signal IMG has been completed (Y in step S100), or after the control unit 2 determines that the execution of the ejection process is not possible (N in step 540, N in step S83, or N in step S94), the control unit 2 stores the held ejection section state information in the storage circuit (not illustrated) included in the control unit 2 (step S110) before the liquid ejecting apparatus 1 stops operating, and thereafter the liquid ejecting apparatus 1 stops operating.

The head unit 3 and the recording head 32 included in the head unit 3 are examples of a print head, and the ejection sections D[1] to D[M] are an example of a plurality of ejection sections. Any one of the ejection sections D[1] to D[M], for example, the ejection section D[1] is an example of a first ejection section. In this case, the piezoelectric element PZ[1] included in the ejection section D[1] is an example of a first piezoelectric element. Any one of ejection sections D[1] to D[M], for example, the ejection section D[m] is an example of a second ejection section. In this case, the piezoelectric element PZ[m] included in the ejection section D[m] is an example of a second piezoelectric element. Any one of ejection sections D[1] to D[M], for example, the ejection section D[m] is an example of a third ejection section. In this case, at least one of the ejection section D[m−1] and the ejection section D[m+1] located adjacent to the ejection section D[m] is an example of a fourth ejection section. The determination unit 7 is an example of a state determination circuit, the maintenance unit 10 is an example of a maintenance unit, the transistor 403 is an example of a switch circuit, the wiring Lb is an example of first wiring, and the wiring Lg is an example of second wiring. The information included in the ejection section state information and indicating the number of ejection sections D in which an ejection abnormality has occurred among the ejection sections D[1] to D[M] included in the head unit 3 is an example of a number of abnormal ejection sections, and the unit period TP in which the ejection process is executed is an example of an ejection period. In the sink circuit 40, the operation mode in which the transistor 403 is controlled to be non-conductive is an example of a first mode, the impedance value between the wiring Lb and the wiring Lg in the state where the transistor 403 is non-conductive is an example of a first impedance value, the operation mode in which the transistor 403 is controlled to be conductive and the switches 422 to 425 are controlled to be non-conductive is an example of a second mode. The impedance value between the wiring Lb and the wiring Lg in the second mode, that is, the resistance value of the resistor 411 is an example of a second impedance value. The operation mode in which the transistor 403 is controlled to be conductive, the switch 422 is controlled to be conductive, and the switches 423 to 425 are controlled to be non-conductive is an example of a third mode. The impedance value between the wiring Lb and the wiring Lg in the third mode, that is, the combined resistance value of the resistors 411 and 412 coupled in parallel is an example of a third impedance value.

### 7. Operational Effects

As described above, the liquid ejecting apparatus 1 according to the present embodiment includes: the head unit 3 including the ejection sections D[1] to D[M] including the ejection section D[1] that ejects ink by driving of the piezoelectric element PZ[1], and the ejection section D[m] that ejects ink by driving of the piezoelectric element PZ[m]; the drive circuit 50 that outputs the drive signal COM to be supplied to the upper electrode Zu[1] that is the first end of the piezoelectric element PZ[1] and the upper electrode Zu[m] that is the first end of the piezoelectric element PZ[m]; the reference voltage circuit 530 that outputs the reference voltage signal VBS to be supplied to the lower electrode Zd[1] that is the second end of the piezoelectric element PZ[1] and the lower electrode Zd[m] that is the second end of the piezoelectric element PZ[m]; the determination unit 7 that determines states of the ejection sections D[1] to D[M]; and the sink circuit 40 that switches, in accordance with a result of the determination by the determination unit 7, the impedance value between the wiring Lb through which the reference voltage signal VBS propagates and the wiring Lg through which the signal having the ground electrical potential lower than the electrical potential of the reference voltage signal VBS propagates. In this case, the sink circuit 40 switches, in accordance with the result of the determination by the determination unit 7, the impedance value between the wiring Lb and the wiring Lg to any one of the resistance value in the state where the transistor 403 is non-conductive, the resistance value of the resistor 411 that is less than the resistance value in the state where the transistor 403 is non-conductive, the resistance value that is less than the resistance value of the resistor 411 and equal to the combined resistance value of the resistors 411 and 412 coupled in parallel, the resistance value that is less than the combined resistance value of the resistors 411 and 412 coupled in parallel and is equal to the combined resistance value of the resistors 411 to 413 coupled in parallel, the resistance value that is less than the combined resistance value of the resistors 411 to 413 coupled in parallel and is equal to the combined resistance value of the resistors 411 to 414 coupled in parallel, and the resistance value that is less than the combined resistance value of the resistors 411 to 414 coupled in parallel and is equal to the combined resistance value of the resistors 411 to 415 coupled in parallel.

That is, in the liquid ejecting apparatus 1 according to the present embodiment, it is possible to switch, in accordance with the state of each of the ejection sections D[1] to D[M], the impedance value between the wiring Lb through which the reference voltage signal VBS propagates and the wiring Lg through which the signal having the ground electrical potential propagates. In other words, the sink circuit 40 can switch the sink capability, which is the amount of current that can flow from the wiring, through which the reference voltage signal VBS propagates, toward the wiring, through which the ground electrical potential propagates, to an optimal capability in accordance with the state of each of the ejection sections D[1] to D[M].

Therefore, the liquid ejecting apparatus 1 can continue forming an image on the medium P by an ejection section D, in which an abnormality does not occur, without reducing the quality of the image when an abnormality occurs in an ejection section D including a piezoelectric element PZ. In addition, the liquid ejecting apparatus 1 can stop forming the image on the medium P when an abnormality occurs in an ejection section D including a piezoelectric element PZ and it is difficult to form the image on the medium P by an ejection section D in which an abnormality does not occur, or when the voltage value of the wiring Lb increases due to a cause other than the abnormality occurring in the ejection section D including the piezoelectric element PZ. Therefore, the possibility that the ejection process may be continuously executed in a state where the quality of the image formed on the medium P is reduced is reduced.

As described above, in the liquid ejecting apparatus 1 according to the present embodiment, it is possible to appropriately switch between the continuation and the stop of the image formation on the medium P. Therefore, in the liquid ejecting apparatus 1 according to the present embodiment, it is possible to reduce the possibility that the productivity and the convenience in the liquid ejecting apparatus 1 may be reduced, and it is also possible to reduce the possibility that the quality of the image formed on the medium P in the liquid ejecting apparatus 1 may be reduced.

In addition, the liquid ejecting apparatus 1 according to the present embodiment includes the maintenance unit 10 that executes the maintenance process of restoring the state of the ejection section D, and executes the wiping process of wiping the ejection surface 115 onto which ink is ejected from the head unit 3, and the flushing process of simultaneously ejecting the ink from the plurality of ejection sections D in order to restore the viscosity of the stored ink as the maintenance process. Even in a case where the state of the ejection section D is restored by the maintenance process, the sink circuit 40 switches the sink capability in accordance with a result of the determination by the determination unit 7, and thus in the liquid ejecting apparatus 1 according to the present embodiment, it is possible to further reduce the possibility that the productivity and the convenience may be reduced and it is possible to further reduce the possibility that the quality of the image formed on the medium P may be reduced.

In addition, in the liquid ejecting apparatus 1 according to the present embodiment, since the determination unit 7 determines the states of the plurality of ejection sections D in accordance with residual vibrations generated in the plurality of ejection sections D, it is possible to individually determine the states of the ejection sections D[1] to D[M] with high accuracy. Therefore, the accuracy of the determination of the states of the plurality of ejection sections D in the determination unit 7 is improved, and the accuracy of the switching of the sink capability in the sink circuit 40 is also improved. Therefore, in the liquid ejecting apparatus 1 according to the present embodiment, it is possible to further reduce the possibility that the productivity and the convenience may be reduced, and it is also possible to further reduce the possibility that the quality of the image formed on the medium P may be reduced.

In particular, in the liquid ejecting apparatus 1 according to the present embodiment, even in a case where the amount of current which propagates through the wiring Lb increases in accordance with the state of each of the ejection sections D[1] to D[M], it is possible to reduce the possibility that the productivity and the convenience in the liquid ejecting apparatus 1 may be reduced and it is possible to reduce the possibility that the quality of the image formed on the medium P may be reduced, and thus this is highly effective for a case where a short-circuit abnormality has occurred in any of the piezoelectric elements Pz[1] to Pz[M] included in the respective ejection sections D[1] to D[M] and where an abnormal state that cannot be restored by the maintenance process has occurred.

The embodiments and the modification examples are described above, but the present disclosure is not limited to the embodiments, and can be implemented in various aspects without departing from the spirit and scope of the present disclosure. For example, the above-described embodiments may be appropriately combined.

The present disclosure includes substantially the same configurations (for example, configurations having the same functions, methods, and results, or configurations having the same purposes and effects) as the configurations described in the embodiments. Further, the present disclosure includes configurations in which non-essential portions of the configurations described in the embodiments are replaced. In addition, the present disclosure includes configurations that obtain the same operational effects as those of the configurations described in the embodiments or configurations that can achieve the same purposes as those of the configurations described in the embodiments. In addition, the present disclosure includes configurations in which a known technology is added to the configurations described in the embodiments.

The following contents are derived from the above-described embodiments.

In a first aspect, a liquid ejecting apparatus includes: a print head including a plurality of ejection sections including a first ejection section that ejects liquid by driving of a first piezoelectric element and a second ejection section that ejects liquid by driving of a second piezoelectric element; a drive circuit that outputs a drive signal to be supplied to a first end of the first piezoelectric element and a first end of the second piezoelectric element; a reference voltage circuit that outputs a reference voltage signal to be supplied to a second end of the first piezoelectric element and a second end of the second piezoelectric element; a state determination circuit that determines states of the plurality of ejection sections; and a sink circuit that switches, in accordance with a result of determining the states of the plurality of ejection sections by the state determination circuit, an impedance value between first wiring through which the reference voltage signal propagates and second wiring through which a signal having an electrical potential lower than an electrical potential of the reference voltage signal propagates, wherein the sink circuit has a first mode in which the impedance value is set to a first impedance value, a second mode in which the impedance value is set to a second impedance value less than the first impedance value, and a third mode in which the impedance value is set to a third impedance value less than the second impedance value.

In the liquid ejecting apparatus, the sink circuit switches the impedance value between the first wiring, through which the reference voltage signal propagates, and the second wiring, through which the signal having the electrical potential lower than the electrical potential of the reference voltage signal propagates, between the first impedance value, the second impedance value less than the first impedance value, and the third impedance value less than the second impedance value in accordance with the result of determining the states of the plurality of ejection sections by the state determination circuit, and therefore the sink circuit can switch the amount of current that can flow from the first wiring toward the second wiring to an optimum amount in accordance with each of the states of the plurality of ejection sections.

Therefore, in a case where an abnormality occurs in any one of the plurality of ejection sections and it is possible to form an image on a medium by another ejection section in which an abnormality does not occur, the liquid ejecting apparatus can continue forming the image on the medium without a reduction in the quality of the image. In a case where an abnormality occurs in any one of the plurality of ejection sections and it is difficult to form the image on the medium by another ejection section in which an abnormality does not occur, or when the voltage value of the first wiring increases due to a cause other than an abnormality of an ejection section including a piezoelectric element, it is possible to stop forming the image on the medium. Therefore, in the liquid ejecting apparatus, it is possible to reduce the possibility that the ejection process may be continuously executed in a state where the quality of the image formed on the medium is reduced.

That is, in the liquid ejecting apparatus, it is possible to appropriately switch between the continuation and the stop of the image formation on the medium. Therefore, in the liquid ejecting apparatus according to the present embodiment, it is possible to reduce the possibility that the productivity and the convenience in the liquid ejecting apparatus may be reduced, and it is also possible to reduce the possibility that the quality of an image formed on a medium in the liquid ejecting apparatus may be reduced.

In a second aspect, in the liquid ejecting apparatus according to the first aspect, the first mode, the second mode, and the third mode may be switched in accordance with the number of abnormal ejection sections determined to be abnormal by the state determination circuit among the plurality of ejection sections.

In the liquid ejecting apparatus, the operation of the sink circuit is switched between the first mode, the second mode, and the third mode in accordance with the number of abnormal ejection sections determined to be abnormal by the state determination circuit among the plurality of ejection sections, and thus the sink circuit can switch the amount of current that can flow from the first wiring toward the second wiring to an optimum amount. Therefore, in the liquid ejecting apparatus, it is possible to more appropriately switch between the continuation and the stop of the image formation on the medium, it is possible to further reduce the possibility that the productivity and the convenience in the liquid ejecting apparatus may be reduced, and it is also possible to further reduce the possibility that the quality of the image formed on the medium in the liquid ejecting apparatus may be reduced.

In a third aspect, the liquid ejecting apparatus according to the first aspect may further include a maintenance unit that executes a maintenance process on the ejection sections.

In a fourth aspect, in the liquid ejecting apparatus according to the third aspect, the maintenance unit may execute, as the maintenance process, a wiping process of wiping an ejection surface onto which the liquid is ejected from the print head.

In a fifth aspect, in the liquid ejecting apparatus according to the third aspect, the maintenance unit may execute, as the maintenance process, a flushing process of ejecting the liquid from the plurality of ejection sections in order to restore viscosity of the stored liquid.

The liquid ejecting apparatus according to each of the third to fifth aspects includes the maintenance unit that executes the maintenance process of restoring the states of the ejection sections and executes, as the maintenance process, the wiping process of wiping the ejection surface onto which the liquid is ejected from the print head, or the flushing process of simultaneously ejecting the liquid from the plurality of ejection sections in order to restore the viscosity of the stored liquid. Therefore, even when the states of the ejection sections are restored, the sink circuit switches the impedance value between the first impedance value, the second impedance value less than the first impedance value, and the third impedance value less than the second impedance value in accordance with the result of determining the states of the plurality of ejection sections by the state determination circuit. As a result, the sink circuit switches the amount of current that can flow from the first wiring toward the second wiring to an optimum amount based on the latest states of the ejection sections. Therefore, it is possible to further reduce the possibility that the productivity and convenience of the liquid ejecting apparatus may be reduced, and it is also possible to further reduce the possibility that the quality of the image formed on the medium may be reduced.

In a sixth aspect, in the liquid ejecting apparatus according to the first aspect, the drive circuit may include a class-D amplifier circuit.

In a seventh aspect, in the liquid ejecting apparatus according to the first aspect, the sink circuit may include a discrete component.

In an eighth aspect, in the liquid ejecting apparatus according to the first aspect, a third ejection section determined to be abnormal by the state determination circuit among the plurality of ejection sections may not eject liquid in an ejection period in which liquid is ejected from the print head, and a fourth ejection section located adjacent to the third ejection section and determined not to be abnormal by the state determination circuit among the plurality of ejection sections may eject liquid so as to complement the third ejection section in the ejection period.

In a ninth aspect, in the liquid ejecting apparatus according to the first aspect, the state determination circuit may determine the state of the first ejection section in accordance with a residual vibration generated in the first ejection section, and may determine the state of the second ejection section in accordance with a residual vibration generated in the second ejection section.

In the liquid ejecting apparatus, the state determination circuit determines the state of the first ejection section in accordance with the residual vibration generated in the first ejection section and determines the state of the second ejection section in accordance with the residual vibration generated in the second ejection section, and thus it is possible to individually determine the states of the plurality of ejection sections with high accuracy. Therefore, the accuracy of the determination of the states of the plurality of ejection sections in the state determination circuit is improved, and the accuracy of the switching of the amount of current, which can flow from the first wiring toward the second wiring, by the sink circuit is improved. Therefore, it is possible to further reduce the possibility that the productivity and convenience of the liquid ejecting apparatus may be reduced, and it is also possible to further reduce the possibility that the quality of the image formed on the medium may be reduced.

In a tenth aspect, in the liquid ejecting apparatus according to any one of the first to ninth aspects, the sink circuit may include a switch circuit and a variable resistance circuit, a first end of the switch circuit may be electrically coupled to the first wiring, a second end of the switch circuit may be electrically coupled to a first end of the variable resistance circuit, a second end of the variable resistance circuit may be electrically coupled to the second wiring, the switch circuit may be controlled to be non-conductive between the first end and the second end of the switch circuit in the first mode and may be controlled to be conductive between the first end and the second end of the switch circuit in the second mode and the third mode, and a resistance value between the first end and the second end of the variable resistance circuit in the second mode may be greater than a resistance value between the first end and the second end of the variable resistance circuit in the third mode.

What is claimed is:

1. A liquid ejecting apparatus comprising:
a print head including a plurality of ejection sections including a first ejection section that ejects liquid by driving of a first piezoelectric element and a second ejection section that ejects liquid by driving of a second piezoelectric element;
a drive circuit that outputs a drive signal to be supplied to a first end of the first piezoelectric element and a first end of the second piezoelectric element;
a reference voltage circuit that outputs a reference voltage signal to be supplied to a second end of the first piezoelectric element and a second end of the second piezoelectric element;
a state determination circuit that determines states of the plurality of ejection sections; and
a sink circuit that switches, in accordance with a result of determining the states of the plurality of ejection sections by the state determination circuit, an impedance value between first wiring through which the reference voltage signal propagates and second wiring through which a signal having an electrical potential lower than an electrical potential of the reference voltage signal propagates, wherein
the sink circuit has
a first mode in which the impedance value is set to a first impedance value,
a second mode in which the impedance value is set to a second impedance value less than the first impedance value, and
a third mode in which the impedance value is set to a third impedance value less than the second impedance value.

2. The liquid ejecting apparatus according to claim 1, wherein
the first mode, the second mode, and the third mode are switched in accordance with a number of abnormal ejection sections determined to be abnormal by the state determination circuit among the plurality of ejection sections.

3. The liquid ejecting apparatus according to claim 1, further comprising
a maintenance unit that executes a maintenance process on the ejection sections.

4. The liquid ejecting apparatus according to claim 3, wherein
the maintenance unit executes, as the maintenance process, a wiping process of wiping an ejection surface onto which the liquid is ejected from the print head.

5. The liquid ejecting apparatus according to claim 3, wherein
the maintenance unit executes, as the maintenance process, a flushing process of ejecting the liquid from the plurality of ejection sections in order to restore viscosity of the stored liquid.

6. The liquid ejecting apparatus according to claim 1, wherein
the drive circuit includes a class-D amplifier circuit.

7. The liquid ejecting apparatus according to claim 1, wherein
the sink circuit includes a discrete component.

8. The liquid ejecting apparatus according to claim 1, wherein
a third ejection section determined to be abnormal by the state determination circuit among the plurality of ejection sections does not eject liquid in an ejection period in which liquid is ejected from the print head, and
a fourth ejection section that is located adjacent to the third ejection section and determined not to be abnormal by the state determination circuit among the plurality of ejection sections ejects liquid so as to complement the third ejection section in the ejection period.

9. The liquid ejecting apparatus according to claim 1, wherein
the state determination circuit determines the state of the first ejection section in accordance with a residual vibration generated in the first ejection section, and determines the state of the second ejection section in accordance with a residual vibration generated in the second ejection section.

10. The liquid ejecting apparatus according to claim 1, wherein
the sink circuit includes a switch circuit and a variable resistance circuit,
a first end of the switch circuit is electrically coupled to the first wiring,
a second end of the switch circuit is electrically coupled to a first end of the variable resistance circuit,
a second end of the variable resistance circuit is electrically coupled to the second wiring,
the switch circuit is controlled to be non-conductive between the first end and the second end of the switch circuit in the first mode and is controlled to be conductive between the first end and the second end of the switch circuit in the second mode and the third mode, and
a resistance value between the first end and the second end of the variable resistance circuit in the second mode is greater than a resistance value between the first end and the second end of the variable resistance circuit in the third mode.
